(19) United States
(12) Patent Application Publication
(10) Pub. No.: US 2025/0055302 A1
(43) Pub. Date: Feb. 13, 2025

(54) POWER CONVERTER, CONTROLLER, AND CHARGING CIRCUIT SYSTEMS AND METHODS

(71) Applicant: Murata Manufacturing Co., Ltd., Kyoto (JP)

(72) Inventors: David Giuliano, Bedford, NH (US); Ibrahim Sezan, San Diego, CA (US); Andrew Borja, San Jose, CA (US)

(21) Appl. No.: 18/792,528

(22) Filed: Aug. 1, 2024

Related U.S. Application Data
(63) Continuation of application No. 18/585,075, filed on Feb. 23, 2024.
Application No. 18/585,075 is a continuation-in-part of application No. 18/446,462, filed on Aug. 8, 2023.

(51) Int. Cl. H02J 7/00

(52) U.S. Cl. CPC H02J 7/007194; H02J 7/00034; H02J 7/0048; H02J 7/005; H02J 2207/20

(57) ABSTRACT

Power converter, controller, and charging circuit systems and methods are provided. In one example, a power converter for use with a programmable power supply circuit includes a charging circuit and a battery. The charging circuit is configured to be coupled to the programmable power supply circuit. The programmable power supply circuit is configured to provide a regulated DC input voltage. The charging circuit includes a dc-dc converter configured to be coupled to the programmable power supply circuit and configured to convert the regulated DC input voltage to a system output voltage at a node. The battery is coupled to the dc-dc converter, and configured to be charged or discharged, directly or indirectly via the node. The charging circuit further includes a charge transistor coupled in series between the dc-dc converter and the battery via the node and configured to enable or disable charging or discharging of the battery.

### CROSS-REFERENCE TO RELATED APPLICATIONS

The present application is a continuation of and claims priority to and the benefits of U.S. patent application Ser. No. 18/585,075, filed on Feb. 23, 2024, which in turn is a continuation-in-part of and claims priority to and the benefits of U.S. patent application Ser. No. 18/446,462, filed on Aug. 8, 2023, the entire contents of all of which are incorporated herein by reference.

### TECHNICAL FIELD

The present disclosure generally relates to power electronic devices, and more particular, for example, to power converter, controller, and charging circuit systems and methods.

### BACKGROUND

Nowadays, many electronic products, such as mobile computing devices and/or communication products (e.g., smart phones, notebook computers, ultra-book computers, tablet devices, etc.), may support various charging schemes. For example, some electronic devices may enable a high-speed charging function using a relative high output power to rapidly charge a battery in the electronic devices to provide better user experience, or enable a maintenance charging mode using a low output power to extend battery life and avoid degradation of the battery. To support charging schemes for different applications or system conditions, battery chargers need to adjust an output voltage and/or current dynamically in response to commands from the electronic products. Accordingly, it has become a critical challenge in the field to design high-efficiency power conversion circuits, improve charging capability and circuit design flexibility, and to meet power requirements for different electronic products.

### SUMMARY

Embodiments of the present disclosure provide a power converter for use with a programmable power supply circuit. In some embodiments, the power converter includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first dc-dc converter, and configured to be charged or discharged, directly or indirectly via the output node. The charging circuit further includes a charger transistor electrically coupled in series between the first de-dc converter and the battery via the output node and configured to enable or disable charging or discharging of the battery.

In some embodiments, the power converter includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first de-de converter, and configured to be charged or discharged, directly or indirectly via the output node. The charging circuit further includes a second dc-dc converter electrically coupled in series between the programmable power supply circuit and the battery. One of the first dc-dc converter and the second dc-dc converter is an unregulated converter.

In some embodiments, the power converter includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first dc-dc converter, and configured to be charged or discharged, directly or indirectly via the output node. The charging circuit further includes a second dc-dc converter electrically coupled in series between the programmable power supply circuit and the battery, and the first de-de converter and the second dc-dc converter are configured to operate simultaneously.

In some embodiments, the power converter includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first dc-dc converter, and configured to be charged or discharged, directly or indirectly via the output node. The charging circuit further includes a boost converter or a charge pump converter electrically coupled between the battery and the output node.

In some embodiments, the power converter includes a charging circuit and a battery. The charging circuit is electrically coupled to the programmable power supply circuit, the programmable power supply circuit being configured to provide a regulated DC voltage as a system output voltage at an output node. The charging circuit includes a first dc-dc converter electrically coupled to the programmable power supply circuit at the output node, and configured to perform a voltage conversion between the system output voltage and a battery voltage. The battery is electrically coupled to the first dc-dc converter, and configured to be charged or discharged, directly or indirectly, based on the battery voltage.

Embodiments of the present disclosure provide a method for charging and discharging a battery. In some embodiments, the method includes: during a first period, converting, by a first dc-dc converter electrically coupled to a programmable power supply circuit, a regulated DC input voltage to a system output voltage at an output node; during a charging period of the first period, charging a battery electrically coupled to the first dc-dc converter, directly or indirectly via the output node, based on the system output voltage; and during a second period, discharging the battery to provide the system output voltage, via the output node. The regulated DC input voltage is outputted by the programmable power supply circuit during the first period.

In some embodiments, the method includes: during a charging period of a first period, charging, by a first dc-dc converter electrically coupled to a programmable power supply circuit at an output node, a battery electrically coupled to the first dc-dc converter, directly or indirectly via the output node, based on a system output voltage by performing a voltage conversion between the system output voltage and a battery voltage of the battery; and during a second period, discharging the battery to provide the system output voltage, via the output node. The system output voltage is a regulated DC voltage outputted by the programmable power supply circuit at the output node during the first period.

Embodiments of the present disclosure provide a method for controlling a charging circuit. The method includes: receiving battery information of a battery from an electrical device to be charged; receiving one or more characteristic parameters from the electrical device; selecting, from multiple charging mode candidates, a target charging mode according to the battery information and the one or more characteristic parameters; and controlling a controller to adjust one or more operating parameters of the charging circuit based on the selected target charging mode for charging the electrical device.

Embodiments of the present disclosure provide a controller for controlling a charging circuit. The controller includes a memory storing a set of instructions and one or more processors coupled to the memory and configured to execute the set of instructions to cause the controller to perform operations including: selecting, from multiple charging mode candidates, a target charging mode according to battery information of a battery and one or more characteristic parameters received from an electrical device to be charged; and adjusting one or more operating parameters of the charging circuit based on the selected target charging mode for charging the electrical device.

Embodiments of the present disclosure provide a charging device. The charging device includes a charging circuit and a controller. The charging circuit is electrically coupled to a programmable power supply circuit, the programmable power supply circuit being configured to provide a regulated DC input voltage. The charging circuit includes a first dc-dc converter electrically coupled to the programmable power supply circuit and configured to convert the regulated DC input voltage to an output voltage at an output node. The controller is configured to: receive battery information from an electrical device to be charged; receive one or more characteristic parameters; select, from multiple charging mode candidates, a target charging mode according to the battery information and the one or more characteristic parameters; and adjust one or more operating parameters of the charging circuit based on the selected target charging mode for charging an electrical device.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

### BRIEF DESCRIPTION OF THE DRAWINGS

Embodiments and various aspects of the present disclosure are illustrated in the following detailed description and the accompanying figures. It is noted that, in accordance with standard practice in the industry, various features are not drawn to scale. In fact, the dimensions of the various features may be arbitrarily increased or reduced for clarity of discussion.

FIG. 1 is a block diagram of an exemplary power converter, in accordance with some embodiments of the present disclosure.

FIG. 2 is a block diagram of another exemplary power converter, in accordance with some embodiments of the present disclosure.

FIG. 3A is a block diagram of another exemplary power converter, in accordance with some embodiments of the present disclosure.

FIG. 3B illustrates power flow during a discharging phase of the battery in the power converter of FIG. 3A, in accordance with some embodiments of the present disclosure.

FIG. 3C illustrates power flow during a charging phase of the battery in the power converter of FIG. 3A, in accordance with some embodiments of the present disclosure.

FIG. 4 is a block diagram of another exemplary power converter, in accordance with some embodiments of the present disclosure.

FIG. 5 is a block diagram of another exemplary power converter, in accordance with some embodiments of the present disclosure.

FIG. 6 is a block diagram of another exemplary power converter, in accordance with some embodiments of the present disclosure.

FIG. 7A is a block diagram of another exemplary power converter, in accordance with some embodiments of the present disclosure.

FIG. 7B illustrates exemplary power flows during a discharging phase of the battery in the power converter of FIG. 7A, in accordance with some embodiments of the present disclosure.

FIG. 7C illustrates exemplary power flows during a charging phase of the battery in the power converter of FIG. 7A, in accordance with some embodiments of the present disclosure.

FIG. 8 is a block diagram of another exemplary power converter, in accordance with some embodiments of the present disclosure.

FIG. 9 is a flowchart of a method for charging and discharging a battery, in accordance with some embodiments of the present disclosure.

FIG. 10 is a flowchart of another method for charging and discharging a battery, in accordance with some embodiments of the present disclosure.

FIG. 11 is a block diagram of an example charging system for an electrical device, in accordance with some embodiments of the present disclosure.

FIG. 12 is a diagram illustrating charging characteristics of multiple charging mode candidates, in accordance with some embodiments of the present disclosure.

FIG. 13 is a flowchart of a method for controlling a charging circuit, in accordance with some embodiments of the present disclosure.

FIG. 14 is a diagram of an example charging mode selector, in accordance with some embodiments of the present disclosure.

FIG. 15 is a diagram illustrating an example lookup table (LUT) containing the candidate sets of the operating parameters, in accordance with some embodiments of the present disclosure.

FIG. 16 is a diagram illustrating a performance plane for the charging modes, in accordance with some embodiments of the present disclosure.

FIG. 17 is a diagram illustrating a mapping between a training set and a corresponding resultant set of the neural network, in accordance with some embodiments of the present disclosure.

FIG. 18A is a block diagram of an example charging circuit, in accordance with some embodiments of the present disclosure.

FIG. 18B to FIG. 18E illustrate example charging modes and corresponding power flows in the charging circuit of FIG. 18A, in accordance with some embodiments of the present disclosure.

FIG. 19 to FIG. 23 are block diagrams of example charging circuits, in accordance with some embodiments of the present disclosure.

FIG. 24A is a block diagram of another example charging circuit, in accordance with some embodiments of the present disclosure.

FIG. 24B and FIG. 24C illustrate example power flows in the charging circuit of FIG. 24A, in accordance with some embodiments of the present disclosure.

FIG. 25 is a block diagram of another example charging circuit, in accordance with some embodiments of the present disclosure.

### DETAILED DESCRIPTION

The following disclosure provides many exemplary embodiments, or examples, for implementing different features of the provided subject matter. Specific simplified examples of components and arrangements are described below to explain the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this document, the term “coupled” may also be termed as “electrically coupled”, and the term “connected” may be termed as “electrically connected”. “Coupled” and “connected” may also be used to indicate that two or more elements cooperate or interact with each other.

In accordance with various embodiments, as further described herein, various battery charging/discharging topologies are provided to realize a highly efficient power supply system and offer improved charging capability to the battery and/or increased design flexibility. The power converters according to various embodiments can be configured to charge a battery within the converter device and provide a system voltage for various applications (e.g., mobile applications) with different voltage requirements and achieve multi-mode battery charging in response to various scenarios and system conditions.

In some embodiments, the power converter according to various embodiments may dynamically switch between charging/discharging modes in response to various conditions and desired outcomes. The mode selection may be based on commands from a user to provide a personalized power management strategy for the user, and may also be based on commands from a controller to achieve an optimized power management. Examples of the charging/discharging modes may include a high-power charging mode which requires less charging time to complete the charging process, a high-efficiency charging mode which causes less damages to the battery and extends the battery life and the performance of the battery, etc.

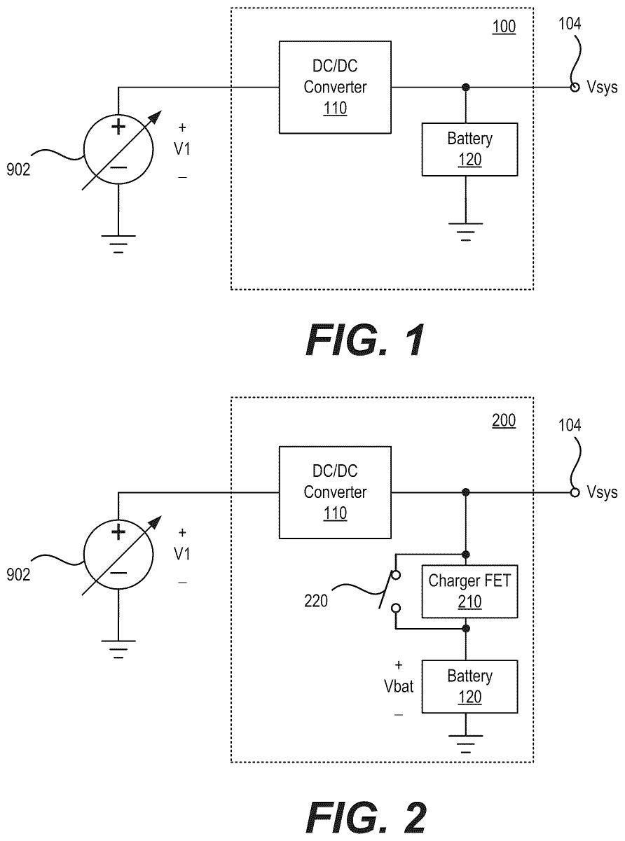

FIG. 1 is a block diagram of an exemplary power converter 100, in accordance with some embodiments of the present disclosure. As used herein, a power converter may refer to an apparatus containing power and electronic components of a power converting circuit. The power converter 100 of FIG. 1 includes a charging circuit including a dc-dc converter 110 and a battery 120 electrically coupled to the dc-dc converter 110. In some embodiments, the charging circuit of the power converter 100 may further include a converter electrically coupled between the battery 120 and an output node 104 providing a system output voltage Vsys. In some embodiments, this converter may be a boost converter or a charge pump converter providing a fixed offset between the battery voltage of the battery 120 and the system output voltage Vsys. Specifically, the charging circuit in FIG. 1 is electrically coupled to a programmable power supply circuit 902. The programmable power supply circuit 902 can be an Adjustable Voltage Source (AVS) and configured to provide a regulated DC input voltage V1. The voltage level of the regulated DC input voltage V1 can be dynamically adjusted by the programmable power supply circuit 902, in response to corresponding commands. In some embodiments, the regulated DC input voltage V1 may be a supply voltage from an AC-DC adaptor connected to the power converter 100. The de-de converter 110 is electrically coupled to the programmable power supply circuit 902 and configured to convert the regulated DC input voltage V1 to the system output voltage Vsys at the output node 104 of the power converter 100. The battery 120 is configured to be charged or discharged, directly or indirectly via the output node 104. As shown in the embodiments of FIG. 1, the battery 120 can be charged by the power outputted by the dc-dc converter 110 directly. In some embodiments, the charging circuit of the power converter 100 may further include a converter (e.g., a boost converter or a charge pump converter) providing a fixed offset between the battery voltage of the battery 120 and the system output voltage Vsys.

In some embodiments, the dc-dc converter 110 may be a buck converter, a boost converter, or a charge pump converter, etc., but the present disclosure is not limited thereto. As used in this disclosure, the term “charge pump” refers to a switched-capacitor network configured to convert an input voltage (e.g., the regulated DC input voltage V1 in FIG. 1) to an output voltage (e.g., the system output voltage Vsys in FIG. 1). Examples of such charge pumps include cascade multiplier, Dickson, ladder, series-parallel, Fibonacci, and Doubler switched-capacitor networks, all of which may be configured as a multi-phase or a single-phase network. In addition, in the context of the present disclosure, power converting circuits that convert a higher input voltage power source to a lower output voltage level are commonly known as step-down or buck converters, because the converter is “bucking” the input voltage. Power converting circuits that convert a lower input voltage power source to a higher output voltage level are commonly known as step-up or boost converters, because the converter is “boosting” the input voltage. In addition, some power converters, commonly known as “buck-boost converters,” may be configured to convert the input voltage power source to the output voltage with a wide range, in which the output voltage may be either higher than or lower than the input voltage. In various embodiments, a power converter may be bidirectional, being either a step-up or a step-down converter depending on how a power source is connected to the converter.

Accordingly, the power converter 100 in FIG. 1 provides a charging mechanism, in which a single dc-dc converter 110 is configured to convert the regulated DC input voltage V1 to the system output voltage Vsys, and the system output voltage Vsys can be used to charge the battery 120 directly and to provide the system voltage required by the circuits or devices in a next power stage connecting to the output node 104. When the programmable power supply circuit 902 is the power source, the power converter 100 receives the regulated DC input voltage V1 from the programmable power supply circuit 902 as the input voltage, with a proper voltage level controlled and regulated by the programmable power supply circuit 902. When the battery 120 is the power source, the converter 130 may be configured to provide the system output voltage Vsys accordingly. Thus, the voltage range of the system output voltage Vsys can be narrower and within a desired voltage range. For example, in some embodiments, the system output voltage Vsys may be in the range of about 9V-5V for a 2S cell (i.e., 2 battery cells connected in series) application in a Narrow Voltage DC (NVDC) Architecture. In addition, the architecture shown in FIG. 1 also provides more flexibility for the regulation of the input voltage of the dc-dc converter 110 to maximize the power efficiency. Because the system output voltage Vsys may be indirectly controlled and regulated according to the regulated DC input voltage V1, the dc-dc converter 110 may be an unregulated converter with a high efficiency. Accordingly, the switching loss of the power converter 100 can be reduced, and the overall efficiency of the power converter 100 can be improved.

FIG. 2 is a block diagram of another exemplary power converter 200, in accordance with some embodiments of the present disclosure. Compared to the power converter 100 of FIG. 1, the power converter 200 further includes a charger transistor 210 and a switch device 220 electrically coupled in parallel to the charger transistor 210. As shown in FIG. 2, the charger transistor 210 is electrically coupled in series between the dc-dc converter 110 and the battery 120 via the output node 104. The charger transistor 210 is configured to enable or disable charging or discharging of the battery 120. For example, when the battery 120 is fully charged, the charger transistor 210 can be controlled in response to a corresponding control command from a controller IC (not shown) to disable the charging of the battery 120 by disconnecting the battery 120 from the dc-dc converter 110. On the other hand, when the battery 120 needs to be charged, the charger transistor 210 can be controlled in response to a corresponding control command from the controller IC to enable the charging of the battery 120 based on the system output voltage Vsys outputted from the dc-dc converter 110.

Similarly, when the power converter 200 receives the regulated DC input voltage V1 and performs the power conversion to provide the system output voltage Vsys based on the regulated DC input voltage V1, the charger transistor 210 can be controlled in response to a corresponding control command from the controller IC to disable the discharging of the battery 120 by disconnecting the battery 120 from the output node 104. On the other hand, when the battery 120 needs to output the system output voltage Vsys for the next stage, the charger transistor 210 can be controlled in response to a corresponding control command from the controller IC to discharge the battery 120 at the desired power level.

The power converter 200 in FIG. 2 can achieve a novel charging mechanism by using an adjustable voltage source (e.g., the regulated DC input voltage V1 from the programmable power supply circuit 902) to replace a fixed voltage source to provide the system output voltage Vsys and provide power to charge the battery 120.

In some embodiments, the switch device 220 is an optional switching element. The switch device 220 in parallel to the charger transistor 210 is configured to bypass the charger transistor 210 when the switch device 220 is closed. Specifically, the switch device 220 can be controlled and used to bypass the charger transistor 210 in response to the power mode when applicable and provide a less resistive power path between the battery 120 and the output node 104. Accordingly, the overall power efficiency can be improved. For example, when the programmable power supply circuit 902 is used at the power source, the power converter 200 may receive the regulated DC input voltage V1 to provide a high efficient system output voltage Vsys. During a Constant Current (CC) mode, the switch device 220 may be enabled to bypass the charger transistor 210. In addition, when the battery 120 is used at the power source, the switch device 220 may also be enabled to bypass the charger transistor 210, so that the battery 120 can provide the system output voltage Vsys directly to the output node 104 of the power converter 200.

In some embodiments, the charging circuit of the power converter 200 may include additional components. The circuit shown in FIG. 2 is an example and not meant to limit the present disclosure. For example, similar to the embodiments of FIG. 1, the charging circuit of the power converter 200 may further include another boost converter or charge pump converter providing a fixed offset between the battery voltage Vbat of the battery 120 and the system output voltage Vsys to ensure that the system output voltage Vsys does not reach or exceed the battery voltage Vbat. In some embodiments, the charging path including the charger transistor 210 can thus be removed accordingly.

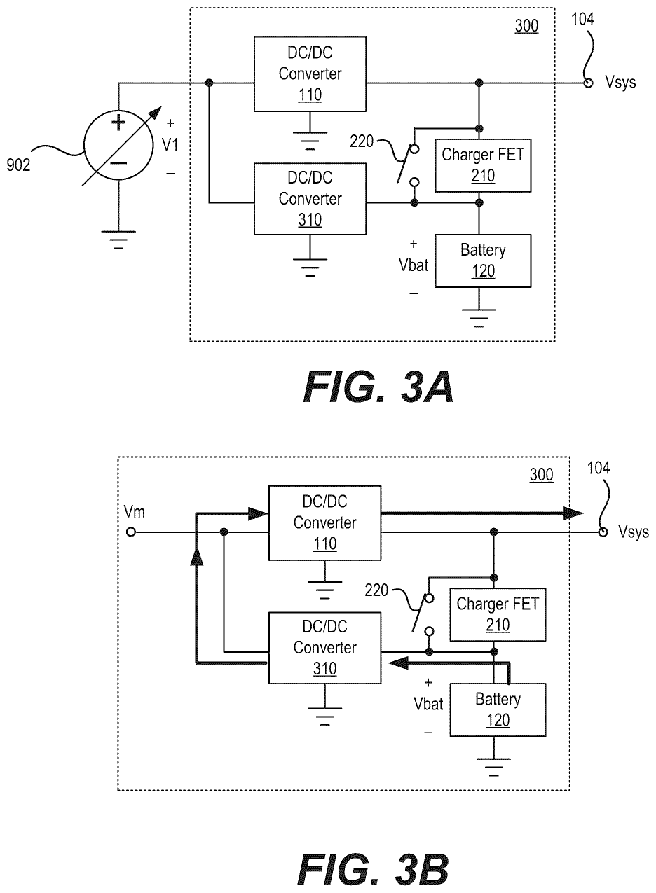

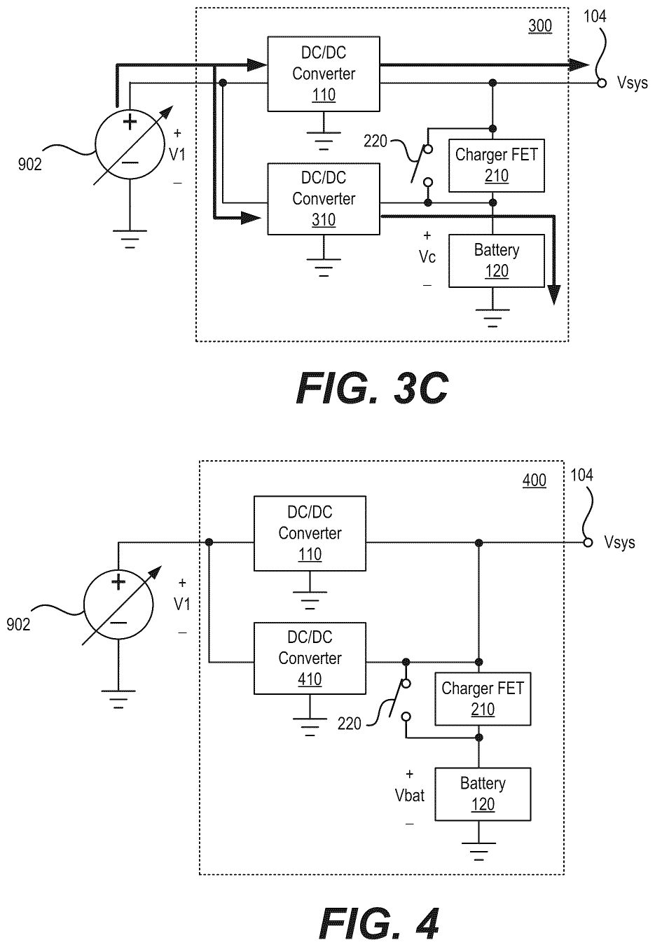

FIG. 3A is a block diagram of another exemplary power converter 300, in accordance with some embodiments of the present disclosure. Compared to the power converter 200 of FIG. 2, the power converter 300 further includes another de-dc converter 310. As shown in FIG. 3A, the dc-dc converter 310 is electrically coupled in series between the programmable power supply circuit 902 and the battery 120. The charger transistor 210 is electrically coupled between the de-dc converter 110 and the dc-dc converter 310. In some embodiments, the dc-dc converter 110 and the dc-dc converter 310 are configured to operate simultaneously.

For example, FIG. 3B illustrates the power flow during a discharging phase of the battery 120 in the power converter 300 of FIG. 3A, in accordance with some embodiments of the present disclosure. As shown in FIG. 3B, in the discharging phase of the battery 120, the dc-dc converter 310 may be configured to convert the battery voltage Vbat outputted by the battery 120 to a first voltage (e.g., the voltage Vm) received by the de-dc converter 110. The dc-dc converter 110 is configured to regulate and provide the system output voltage Vsys, in response to the first voltage (e.g., the voltage Vm) from the dc-dc converter 310.

For example, FIG. 3C illustrates the power flow during a charging phase of the battery 120 in the power converter 300 of FIG. 3A, in accordance with some embodiments of the present disclosure. As shown in FIG. 3C, in the charging phase of the battery 120, the dc-dc converter 110 is configured to provide the system output voltage Vsys, in response to the regulated DC input voltage V1 from the programmable power supply circuit 902. The dc-dc converter 310 is configured to provide a charging voltage Vc to the battery 120, in response to the regulated DC input voltage V1 from the programmable power supply circuit 902.

In various embodiments, different converter types can be applied to implement a high-efficient converter for the dc-dc converter 310. For example, the dc-dc converter 310 may be a magnetic-based unregulated converter, an LLC converter, a switched-capacitor (SC)-based converter, etc. In some embodiments, one of the dc-dc converter 110 and the de-dc converter 310 can be an unregulated converter, and the other one of the dc-dc converter 110 and the dc-dc converter 310 can be a regulated converter. During the discharging phase of the battery 120, the system output voltage Vsys can be regulated by the regulated converter. During the charging phase of the battery 120, the system output voltage Vsys and the charging voltage Vc can be regulated by the regulated converter and the programmable power supply circuit 902 providing the regulated DC input voltage V1.

For example, if the dc-dc converter 110 is an unregulated converter, then during the discharging phase of the battery 120 shown in FIG. 3B, the system output voltage Vsys can be indirectly controlled and regulated by the dc-dc converter 310 providing a regulated voltage Vm. During the charging phase of the battery 120 shown in FIG. 3C, the system output voltage Vsys can be indirectly controlled and regulated by the programmable power supply circuit 902 providing the regulated DC input voltage V1, and the charging voltage Vc can be regulated by the dc-dc converter 310.

In another example, if the dc-dc converter 310 is an unregulated converter, then during the discharging phase of the battery 120 shown in FIG. 3B, the system output voltage Vsys can be controlled and regulated by the dc-dc converter 110 outputting the system output voltage Vsys. During the charging phase of the battery 120 shown in FIG. 3C, the charging voltage Vc can be indirectly controlled and regulated by the programmable power supply circuit 902 providing the regulated DC input voltage V1, and the system output voltage Vsys can be regulated by the dc-dc converter 110. The embodiments of FIGS. 3A-3C can achieve a flash charging mechanism by using one regulating converter and one high efficiency unregulated converter to provide the system output voltage Vsys at a high voltage (HV) level and provide the charging voltage Vc at a desired level for the battery 120. By running the dc-dc converter 110 and the dc-dc converter 310 simultaneously, the overall power efficiency can be improved. In some embodiments, different charging/discharging modes can be achieved by selecting the converters to be enabled or disabled.

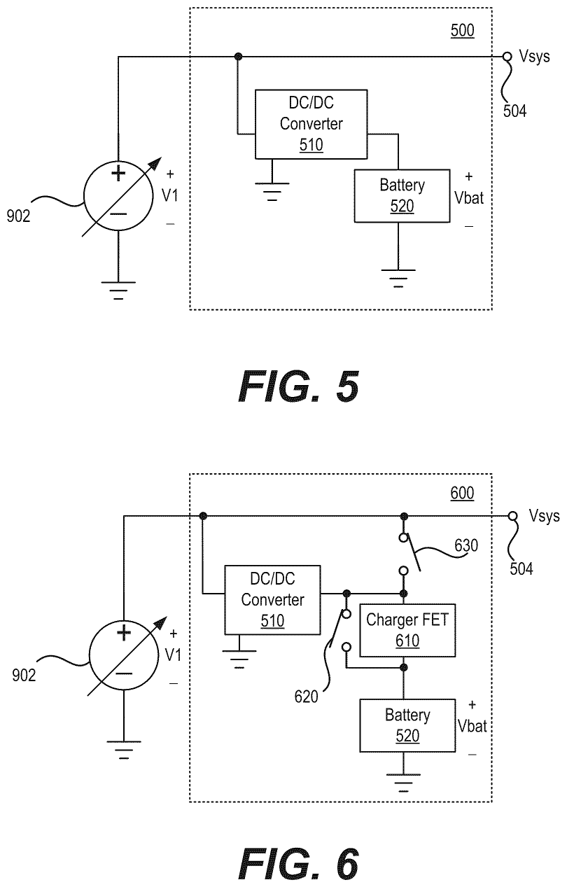

FIG. 4 is a block diagram of another exemplary power converter 400, in accordance with some embodiments of the present disclosure. Compared to the power converter 300 of FIGS. 3A-3C, the power converter 400 also includes another dc-dc converter 410, and the dc-dc converter 110 and the dc-dc converter 410 are electrically coupled in parallel.

In some embodiments, the dc-dc converter 410 and the de-de converter 110 operate at the same conversion ratio. In some embodiments, one of the de-de converter 410 and the dc-dc converter 110 may be unregulated. By arranging the dc-dc converter 410 and the de-dc converter 110 in parallel, the power path providing the system output voltage Vsys or the charging voltage to the battery 120 can be optimized with the dc-dc converter 410 and the de-de converter 110 operating together to provide additional power.

Similar to the power converter 300, in some embodiments, the switch device 220 is electrically coupled in parallel to the charger transistor 210. In a charging phase of the battery 120, the switch device 220 is closed to bypass the charger transistor 210 to achieve a high efficiency charging to the battery 120. In a discharging phase of the battery 120, the switch device 220 is closed to bypass the charger transistor 210 to provide the system output voltage Vsys from the battery 120. Thus, when the power is drawn from the battery 120, the system output voltage Vsys may be the battery voltage Vbat, instead of a reduced voltage due to the voltage drop across the charger transistor 210.

In some other embodiments, the charging circuit of the power converter 300 or 400 may include additional components. The charging circuits shown in FIGS. 3A-3C and FIG. 4 are examples and not meant to limit the present disclosure. For example, similar to the embodiments of FIG. 1, the charging circuit of the power converter 300 or 400 may further include another boost converter or charge pump converter providing a fixed offset between the battery voltage Vbat of the battery 120 and the system output voltage Vsys to ensure that the system output voltage Vsys does not reach or exceed the battery voltage Vbat, and is at a specific level (e.g., 5V). In some embodiments, the charging path including the charger transistor 210 can thus be removed accordingly.

In the above embodiments of FIG. 1 to FIG. 4, the programmable power supply circuit 902 can be used as an adjustable and dynamic input voltage source to replace the fixed input voltage source in the traditional design. The programmable power supply circuit 902 can be applied to maximize the power efficiency by regulating the input voltage of the dc-dc converter(s) (e.g., dc-dc converters 110, 310, and 410) in the power converters. In some embodiments, the battery 120 can be connected to a boost converter or a charge pump converter for outputting a regulated system output voltage Vsys. Accordingly, the voltage range of the system output voltage Vsys can be narrower. In some embodiments, a fixed offset between the battery voltage Vbat of the battery 120 and the system output voltage Vsys can be ensured.

FIG. 5 is a block diagram of another exemplary power converter 500, in accordance with some embodiments of the present disclosure. Compared to the above embodiments of FIG. 1 to FIG. 4, the power converter 500 is designed for a Wide Voltage DC (WVDC) architecture. The power converter 500 may be configured to provide the system output voltage Vsys with a wider voltage range compared to NVDC architectures in the above embodiments of FIG. 1 to FIG. 4. In some embodiments, in the WVDC architecture, the system output voltage Vsys may be in the voltage range of about 20V-5V, which is broader than the voltage range of about 9V-5V for an exemplary NVDC architecture, but the present disclosure is not limited thereto.

As shown in FIG. 5, the power converter 500 includes a charging circuit including a dc-dc converter 510 and a battery 520 electrically coupled to the de-dc converter 510. Specifically, the charging circuit in FIG. 5 is electrically coupled to a programmable power supply circuit 902. Similar to the embodiments above, the programmable power supply circuit 902 can be an Adjustable Voltage Source (AVS). The programmable power supply circuit 902 is configured to provide the regulated DC voltage V1 as a system output voltage Vsys at an output node 504 of the power converter 500 to the next stage.

The de-de converter 510 is electrically coupled to the programmable power supply circuit 902 at the output node 504 and is configured to perform a voltage conversion between the system output voltage Vsys and a battery voltage Vbat of the battery 520. The battery 520 is electrically coupled to the de-dc converter 510 and configured to be charged or discharged, directly or indirectly, based on the battery voltage Vbat.

The power converter 500 provides a charging mechanism without arranging a charger transistor in the charging circuit of the power converter 500. In some embodiments, the dc-dc converter 510 may be a Low-dropout regulator (LDO).

FIG. 6 is a block diagram of another exemplary power converter 600, in accordance with some embodiments of the present disclosure. The power converter 600 may also be designed for the WVDC architecture. Compared to the power converter 500 of FIG. 5, the power converter 600 further includes a charger transistor 610 and switch devices 620 and 630 electrically coupled to the charger transistor 610.

As shown in FIG. 6, the charger transistor 610 is electrically coupled in series between the dc-dc converter 510 and the battery 520 and configured to enable or disable charging or discharging of the battery 520. The switch device 620 is electrically coupled in parallel to the charger transistor 610 and configured to bypass the charger transistor 610 when the switch device 620 is closed. The switch device 630 is electrically coupled in parallel to the de-de converter 510 and configured to enable a direct charging or discharging between the battery 520 and the output node 504 of the power converter 600 when the switch device 630 is closed. In some embodiments, one or more of the charger transistor 610 and switch devices 620 and 630 may be optional.

In particular, the charger transistor 610 electrically coupled between the de-dc converter 510 and the battery 520 can minimize voltage and current ripples of the battery voltage Vbat across the battery 520. Similar to the embodiments above, the charger transistor 610 and the switch device 620 may be configured to enable or disable charging or discharging of the battery 520. Detailed operations of the charger transistor 610 and the switch device 620 are similar to those of the charger transistor 210 and the switch device 220, and thus are not repeated herein for the sake of brevity.

In some embodiments, the switch device 620 and the switch device 630 can be used to achieve the direct charging of the battery 520. For example, when the battery 520 is charged using the system output voltage Vsys (or the regulated DC voltage V1 from the programmable power supply circuit 902) directly under a direct charging mode, the switch device 620 and the switch device 630 can be closed, in response to a corresponding control command from a controller IC (not shown), to provide a less resistive power path between the battery 520 and the output node 504. Accordingly, the overall power efficiency can be improved.

On the other hand, when a voltage conversion between the system output voltage Vsys and the battery voltage Vbat of the battery 520 is needed, the switch device 630 can be opened, and the battery 520 is charged by the voltage outputted by the dc-dc converter 510. In other words, the charger transistor 610, the switch device 620, and the switch device 630 can be respectively controlled to operate the power converter 600 under various power modes according to various system conditions and desired outcomes to supply the system output voltage Vsys to the load, and to charge or discharge the battery 520 efficiently without causing damages (e.g., over-charge or over-voltage) to the battery 520. In some embodiments, the power converter 600 can dynamically switch between different power modes by detecting the system conditions to optimize its operation automatically.

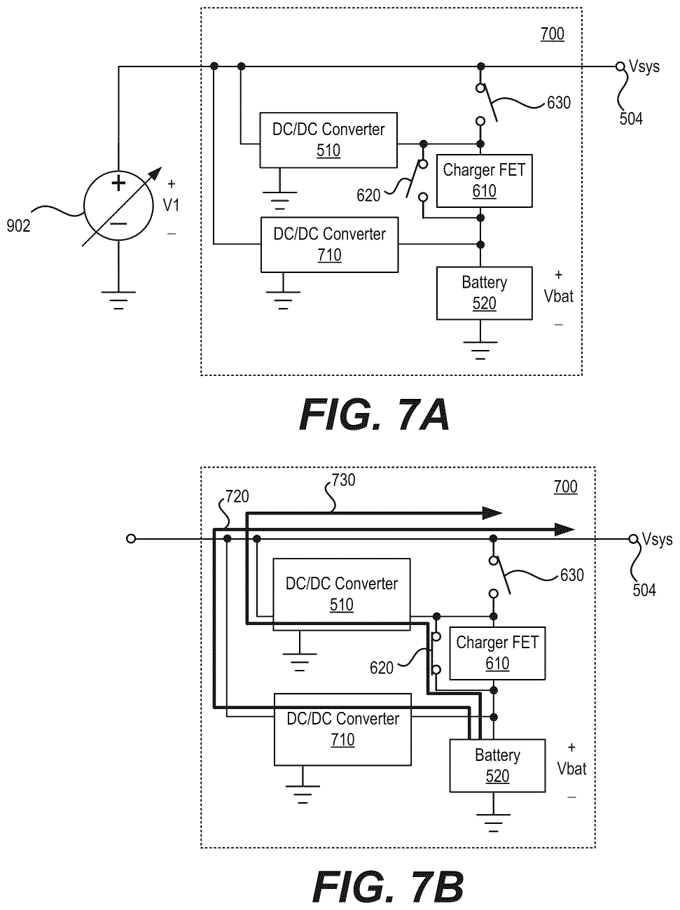

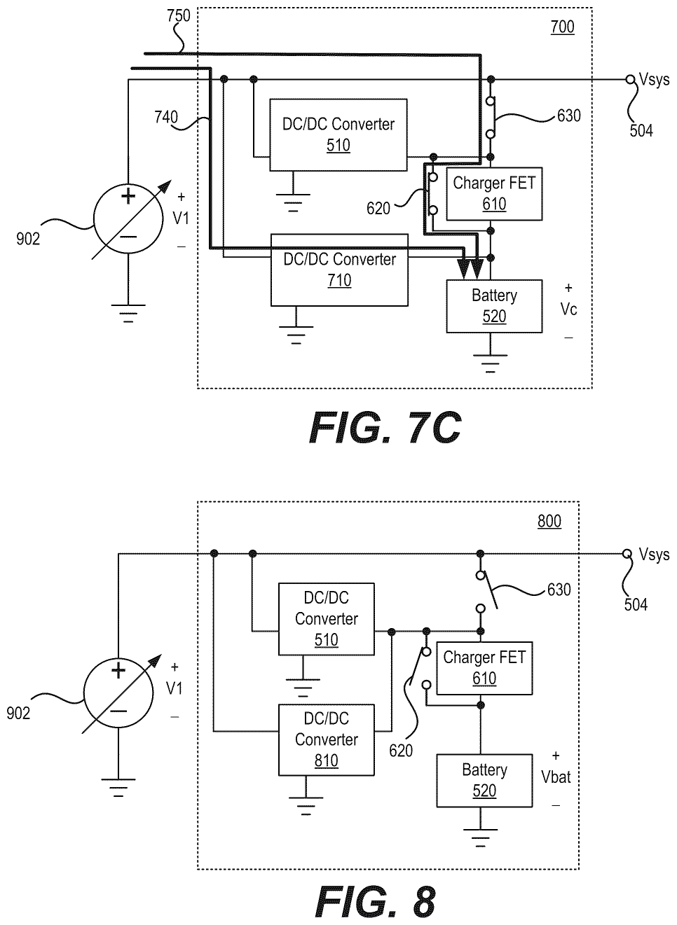

FIG. 7A is a block diagram of another exemplary power converter 700, in accordance with some embodiments of the present disclosure. Compared to the power converter 600 of FIG. 6, the power converter 700 further includes another de-de converter 710. In some embodiments, one of the dc-dc converter 510 and the dc-dc converter 710 may be an unregulated converter, which may be a high-efficiency converter, and the other one of the de-de converter 510 and the de-de converter 710 may be a regulated converter. As shown in FIG. 7A, the dc-dc converter 710 is electrically coupled in series between the programmable power supply circuit 902 and the battery 520. The charger transistor 610 is electrically coupled between the dc-dc converter 510 and the dc-dc converter 710. In some embodiments, the dc-dc converter 510 and the de-de converter 710 are configured to operate simultaneously under certain power modes, but the present disclosure is not limited thereto.

FIG. 7B illustrates exemplary power flows during a discharging phase of the battery 520 in the power converter 700 of FIG. 7A, in accordance with some embodiments of the present disclosure. A power path 720 in FIG. 7B indicates an exemplary power flow during a discharging phase of the battery 520. In the power path 720, during the discharging phase of the battery 520, the dc-dc converter 710 is configured to convert the battery voltage Vbat outputted by the battery 520 to the desired system output voltage Vsys. As shown in FIG. 7B, in some embodiments, the switch device 620 can be closed, in response to a corresponding control command from a controller IC, to provide another power path 730 during the discharging phase of the battery 520, in which the dc-dc converter 510 is configured to convert the battery voltage Vbat outputted by the battery 520 to the desired system output voltage Vsys. Accordingly, the power converter 700 can supply greater output power in response to the system's request, with relative low power-rating dc-dc converters 510 and 710. When the required output power is relatively low, the power converter 700 may also enable one of the dc-dc converters 510 and 710 to reduce the power loss and thus improve the overall power efficiency.

FIG. 7C illustrates exemplary power flows during a charging phase of the battery 520 in the power converter 700 of FIG. 7A, in accordance with some embodiments of the present disclosure. A power path 740 in FIG. 7C indicates an exemplary power flow during a charging phase of the battery 520. In the power path 740, during the charging phase of the battery 520, the dc-dc converter 710 is configured to convert the system output voltage Vsys (or the regulated DC voltage V1 from the programmable power supply circuit 902) to a desired charging voltage Vc to the battery 520, in the condition that the system output voltage Vsys is not within a desired voltage range for charging the battery 520. On the other hand, when the programmable power supply circuit 902 is able to provide the regulated DC voltage V1 at an optimized voltage level as the charging voltage Vc to charge the battery 520 directly, the switch devices 620 and 630 can be closed to provide a power path 750 to enable to a direct charging to improve the efficiency.

It is appreciated that power paths 720-750 shown in FIG. 7B and FIG. 7C are merely examples and not meant to limit the present disclosure. In various embodiments, the power converter 700 can control the dc-dc converters 510 and 710, the charger transistor 610, and the switch devices 620 and 630 accordingly to operate at a desired charging or discharging mode to charge or discharge the battery 520 and output the system output voltage Vsys according to the system's needs using the programmable power supply circuit 902 or the battery 520 as the power source.

FIG. 8 is a block diagram of another exemplary power converter 800, in accordance with some embodiments of the present disclosure. Compared to the power converter 700 of FIGS. 7A-7C, the power converter 800 also includes another dc-dc converter 810. Similar to the embodiments of FIGS. 7A-7C, one of the dc-dc converter 510 and the dc-dc converter 810 may be an unregulated converter, and the other one of the dc-dc converter 510 and the dc-dc converter 810 may be a regulated converter.

As shown in FIG. 8, the dc-dc converters 510 and 810 are electrically coupled in parallel. In some embodiments, the de-dc converter 510 and the de-de converter 810 operate at the same conversion ratio. By arranging the dc-dc converter 510 and the de-dc converter 810 in parallel, the power path providing the system output voltage Vsys or the charging voltage to the battery 520 can be optimized with the dc-dc converter 510 and the dc-dc converter 810 operating together to provide additional power. Thus, similar to the power converter 700 of FIGS. 7A-7C, the power converter 800 can also supply greater output power in response to the system's request, with relatively low power-rating dc-dc converters 510 and 810 to achieve a flash charging. When the required output power is relatively low, the power converter 800 may also enable one of the dc-dc converters 510 and 810 to reduce the power loss and thus improve the overall power efficiency.

Similar to the power converter 700, in some embodiments, the switch device 620 is electrically coupled in parallel to the charger transistor 610. In the charging phase of the battery 520, the switch device 620 can be closed to bypass the charger transistor 610 to achieve high-efficiency charging to the battery 520. In the discharging phase of the battery 520, the switch device 620 may be closed to bypass the charger transistor 610 to provide the system output voltage Vsys from the battery 520 directly. Thus, when the power is drawn from the battery 520, the system output voltage Vsys may be the battery voltage Vbat, instead of a reduced voltage due to the voltage drop across the charger transistor 610.

In some embodiments, one or both of the dc-dc converters 510 and 810 may be a boost converter or a charge pump converter to provide a fixed offset between the battery voltage Vbat of the battery 520 and the system output voltage Vsys to ensure that the system output voltage Vsys is at a specific level, when one or both of the switch devices 620 and 630 are opened and the power flows through one or both of the dc-dc converters 510 and 810. In some other embodiments, the charging circuit of the power converter 700 or 800 may include additional components. The charging circuits shown herein are examples and not meant to limit the present disclosure.

In the above embodiments of FIG. 5 to FIG. 8, the programmable power supply circuit 902 can be used as an adjustable and dynamic input voltage source in various wide voltage DC architectures to replace the fixed input voltage source in the traditional design. The programmable power supply circuit 902 can be applied to maximize the power efficiency by regulating the input voltage of the dc-dc converter(s) (e.g., dc-dc converters 510, 710, and 810) in the power converters. In some embodiments, the battery 520 can be connected to a boost converter or a charge pump converter for outputting a regulated system output voltage Vsys. Accordingly, the voltage range of the system output voltage Vsys can be narrower. In some embodiments, a fixed offset between the battery voltage Vbat of the battery 520 and the system output voltage Vsys can be ensured.

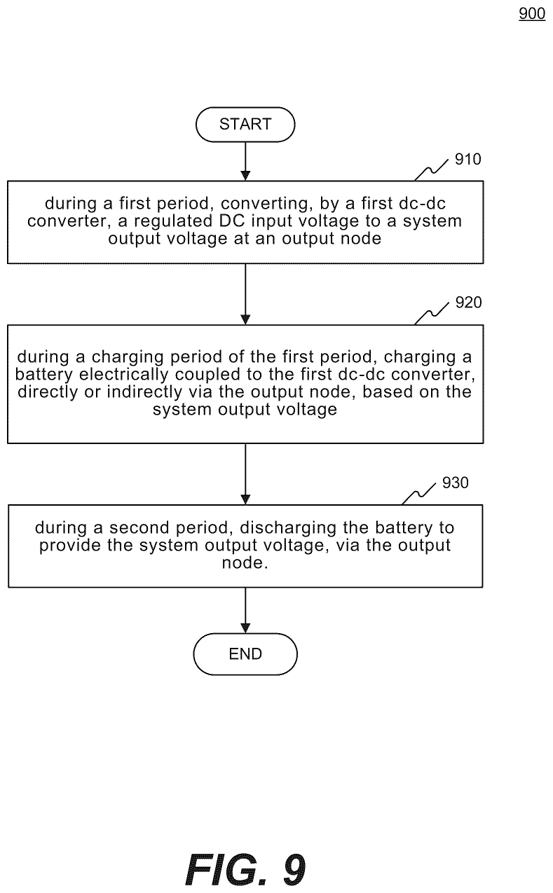

FIG. 9 is a flowchart of a method 900 for charging and discharging a battery, in accordance with some embodiments of the present disclosure. It is understood that additional operations may be performed before, during, and/or after the method 900 depicted in FIG. 9, and that some other processes may only be briefly described herein. The method 900 can be performed by a power converter, e.g., any of the power converters 100, 200, 300 or 400 illustrated in the embodiments of FIG. 1-FIG. 4 above, but the present disclosure is not limited thereto.

As shown in FIG. 9, the method 900 includes operations 910, 920 and 930. In operation 910, during a first period, a programmable power supply circuit (e.g., programmable power supply circuit 902 in FIG. 1) is electrically coupled to the power converter and used as a power source. The power converter is configured to convert, by a first de-de converter (e.g., dc-dc converter 110 in FIG. 1) electrically coupled to the programmable power supply circuit, a regulated DC input voltage (e.g., regulated DC input voltage V1 in FIG. 1) outputted by the programmable power supply circuit during the first period to a system output voltage (e.g., system output voltage Vsys in FIG. 1) at an output node (e.g., output node 104 in FIG. 1). In some embodiments, the first dc-dc converter may be a boost converter or a charge pump converter.

In operation 920, during a charging period of the first period, the power converter is configured to charge a battery (e.g., battery 120 in FIG. 1) electrically coupled to the first dc-dc converter, directly or indirectly via the output node, based on the system output voltage.

In operation 930, during a second period, the battery is used as a power source, and the power converter is configured to discharge the battery to provide the system output voltage, via the output node.

In some embodiments, in the operation 920 during the charging period or the operation 930 during the second period, the power converter may be configured to enable or disable charging or discharging of the battery via a charger transistor (e.g., charger transistor 210 in FIG. 2) electrically coupled in series between the first dc-dc converter and the battery via the output node. In addition, in some embodiments, in the operation 920 or 930, the power converter may be configured to, during the charging period or the second period, close a switch device electrically coupled in parallel to the charger transistor to bypass the charger transistor. Accordingly, the power converter may provide a less resistive power path to improve the overall power efficiency.

In some embodiments, the method 900 may further include operating multiple dc-dc converters electrically coupled to each other. For example, the power converter may be configured to operate the first dc-dc converter and a second de-de converter (e.g., dc-dc converter 310 or 410 in FIGS. 3A-3C or FIG. 4) electrically coupled in series between the programmable power supply circuit and the battery simultaneously to provide the system output voltage at the output node. One of the first dc-dc converter and the second de-de converter may be an unregulated converter. In some embodiments, the charger transistor may be electrically coupled between the first dc-dc converter and the second dc-dc converter. In some other embodiments, the first dc-dc converter and the second dc-dc converter may be electrically coupled in parallel.

For example, as previously discussed in FIG. 3B, operations of operating the first dc-dc converter and the second dc-dc converter may include during the second period, converting, by the second dc-dc converter, a battery voltage (e.g., battery voltage Vbat in FIG. 3B) outputted by the battery to a first voltage (e.g., voltage Vm in FIG. 3B) and regulating the first voltage, by the first dc-dc converter, to provide the system output voltage.

In some embodiments, as previously discussed in FIG. 3C, operations of operating the first dc-dc converter and the second dc-dc converter may include during the charging period, regulating and providing the system output voltage, by the first dc-dc converter, in response to the regulated DC input voltage from the programmable power supply circuit, and providing a charging voltage (e.g., charging voltage Vc in FIG. 3C) to the battery, by the second dc-dc converter, in response to the regulated DC input voltage from the programmable power supply circuit.

In addition, as previously discussed in FIGS. 2-4, the method 900 for charging and discharging the battery may further include during the charging period, closing a switch device (e.g., switch device 220 in FIGS. 2-4) electrically coupled in parallel to the charger transistor to bypass the charger transistor, and/or during the second period, closing the switch device to bypass the charger transistor to provide the system output voltage from the battery. Accordingly, the power converter may provide a less resistive power path to improve the overall power efficiency.

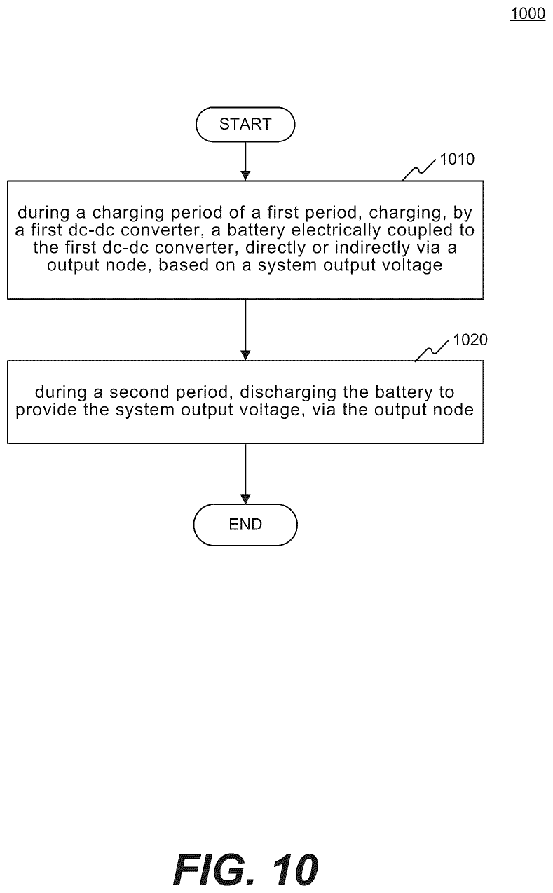

FIG. 10 is a flowchart of another method 1000 for charging and discharging a battery, in accordance with some embodiments of the present disclosure. It is understood that additional operations may be performed before, during, and/or after the method 1000 depicted in FIG. 10, and that some other processes may only be briefly described herein. The method 1000 can be performed by a power converter, e.g., any of the power converters 500, 600, 700 or 800 illustrated in the embodiments of FIG. 5-FIG. 8 above, but the present disclosure is not limited thereto.

As shown in FIG. 10, the method 1000 includes operations 1010 and 1020. In operation 1010, during a first period, a programmable power supply circuit (e.g., programmable power supply circuit 902 in FIG. 5) is electrically coupled to the power converter and used as a power source. During a charging period of the first period, the power converter is configured to charge, by a first dc-dc converter (e.g., dc-dc converter 510 in FIG. 5), a battery (e.g., battery 520 in FIG. 5) electrically coupled to the first dc-dc converter, directly or indirectly. In particular, the first dc-dc converter is electrically coupled to the programmable power supply circuit at an output node (e.g., output node 504 in FIG. 5), and the power converter is configured to charge the battery via the output node, based on a system output voltage (e.g., system output voltage Vsys in FIG. 5) by performing a voltage conversion between the system output voltage and a battery voltage (e.g., battery voltage Vbat in FIG. 5) of the battery. The system output voltage is a regulated DC voltage outputted by the programmable power supply circuit at the output node during the first period.

In operation 1020, during a second period, the battery is used as a power source, and the power converter is configured to discharge the battery to provide the system output voltage, via the output node.

As previously discussed in FIG. 6, in operations 1010 and 1020, the method 1000 may further include enabling or disabling charging or discharging of the battery via a charger transistor (e.g., charger transistor 610 in FIGS. 6-8) electrically coupled in series between the first dc-dc converter and the battery via the output node. In addition, the power converter may be configured to, during the charging period or the second period, close a first switch device (e.g., switch device 620 in FIGS. 6-8) electrically coupled in parallel to the charger transistor to bypass the charger transistor. The power converter may also be configured to, during the charging period or the second period, closing a second switch device (e.g., switch device 630 in FIGS. 6-8) electrically coupled in parallel to the first dc-dc converter to enable a direct charging or discharging between the battery and the output node.

As previously discussed in FIGS. 7A-7C and 8, the method 1000 may further include operating the first dc-dc converter and a second dc-dc converter (e.g., dc-dc converter 710 or 810 in FIGS. 7A-7C and 8) electrically coupled between the programmable power supply circuit and the charger transistor. In some embodiments, one of the first dc-dc converter and the second dc-dc converter is an unregulated converter, and the other one of the first dc-dc converter and the second dc-dc converter is a regulated converter. As previously discussed in FIGS. 7A-7C, the charger transistor may be electrically coupled between the first dc-dc converter and the second dc-dc converter. As previously discussed in FIG. 8, the first dc-dc converter and the second dc-dc converter may be electrically coupled in parallel. By using multiple dc-dc converters, the power converter can supply greater output power in response to the system's request, with relative low power-rating dc-dc converters, and operate under different charging or discharging modes according to the different scenarios and system conditions by controlling the dc-dc converters respectively. Details of the operations have been discussed above and thus are not repeated herein for the sake of brevity.

In accordance with various embodiments, various battery charging/discharging topologies are provided to realize a highly efficient power supply system and offer improved charging capability to the battery and/or increased design flexibility compared to existing solutions. The proposed power converters can be configured to charge a battery within the converter device and provide a system voltage for various mobile applications with different voltage requirements and achieve multi-mode battery charging in response to various scenarios and system conditions.

In some embodiments, the power converter may dynamically switch between charging/discharging modes in response to various conditions and desired outcomes. The mode selection may be based on commands from a user to provide a personalized power management strategy for the user, and may also be based on commands from a controller to achieve an optimized power management. Examples of the charging/discharging modes may include a high-power charging mode which requires less charging time to complete the charging process, a high-efficiency charging mode which causes less damages to the battery and extends the battery life and the performance of the battery, etc.

In accordance with various embodiments, as further described herein, various charging circuit architectures are provided to realize a highly efficient power supply system, offer improved charging mode candidates, and increase design flexibility. The charging devices or modules according to various embodiments can be configured to charge an internal battery within the charging devices or modules and provide the output voltage for charging an electronic device. The user or the controller can leverage the flexibility provided by proposed charging architectures and control methods, so that the charging devices or modules can dynamically switch between different charging modes automatically or in response to manual commands, to adjust the charging efficiency, the charging power, or the required charging time to meet different charging requirements in various applications, and achieve multi-mode battery charging in response to various scenarios and system conditions.

In some embodiments, the charging devices or modules according to various embodiments may dynamically switch between different charging/discharging modes in response to various conditions and desired outcomes in real-time. The mode selection may be based on commands from a user to provide a personalized power management strategy for the user, and may also be based on commands from a controller to achieve an optimized power management. Examples of the charging/discharging modes may include a high-power charging mode which requires less charging time to complete the charging process, a high-efficiency charging mode which causes less damages to the battery and extends the battery life and the performance of the battery, various intermediate charging modes balancing the trade-off between the charging time and the efficiency, etc.

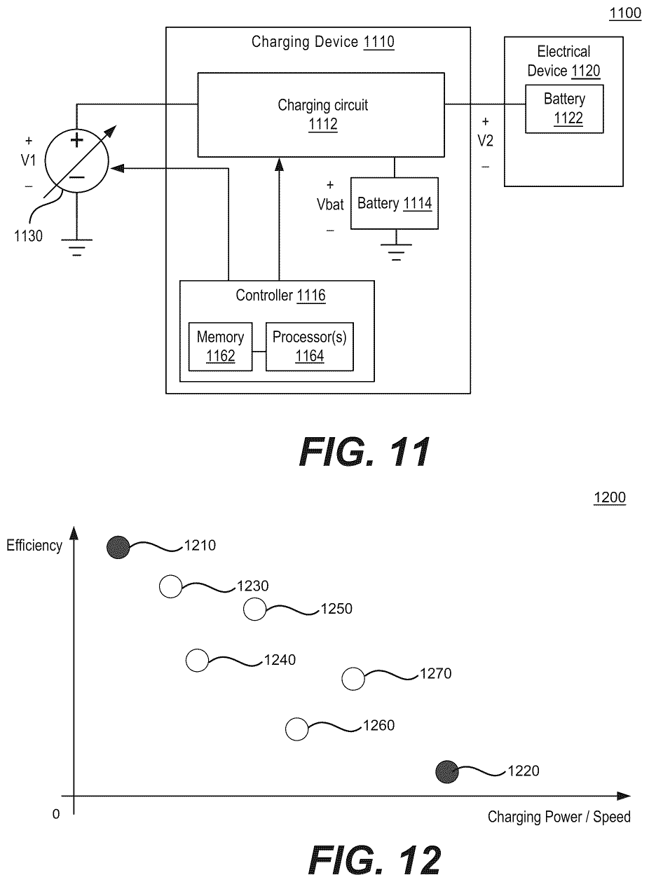

FIG. 11 is a block diagram of an example charging system 1100 for an electrical device, in accordance with some embodiments of the present disclosure. The charging system 1100 of FIG. 11 includes a charging device 1110 having a charging circuit 1112, a battery 1114 electrically coupled to the charging circuit 1112, and a controller 1116 for controlling the charging circuit 1112. The charging circuit 1112 is electrically coupled to an electrical device 1120 having an internal battery 1122, and configured to charge the electrical device 1120 by the control of the controller 1116. The controller 1116 includes a memory 1162 and one or more processors 1164 coupled to the memory 1162. The charging system 1100 also includes a programmable power supply circuit 1130 as the power source of the charging device 1110.

Specifically, the charging circuit 1112 in FIG. 11 is electrically coupled to the programmable power supply circuit 1130. The programmable power supply circuit 1130 can be an Adjustable Voltage Source (AVS) and configured to provide a regulated DC input voltage V1. The voltage level of the regulated DC input voltage V1 can be dynamically adjusted by the programmable power supply circuit 1130, in response to corresponding commands from the controller 1116. In some embodiments, the regulated DC input voltage V1 may be a supply voltage from an AC-DC adaptor. The dc-dc converter(s) in the charging circuit 1112 may be electrically coupled to the programmable power supply circuit 1130 and configured to convert the regulated DC input voltage V1 to an output voltage V2 at an output node of the charging device 1110. In some embodiments, the battery 1114 within the charging device 1110 is configured to be charged or discharged, directly or indirectly by the power from the charging circuit 1112 or the programmable power supply circuit 1130. The output node of the charging device 1110 can be electrically coupled, directly or via a separate charging cable, to one or more electrical devices 1120 having the internal battery 1122 for supplying the power required by the electrical device(s) 1120. Thus, the battery 1122 in the electrical device 1120 can be charged accordingly.

In some embodiments, the charging circuit 1112 may include one or more dc-dc converters to perform the power conversion between the regulated DC input voltage V1, the output voltage V2, and/or the battery voltage Vbat of the battery 1114 within the charging device 1110. As used herein, a power converter may refer to an apparatus containing power and electronic components of a power converting circuit. For example, the charging circuit 1112 may include a buck converter, a boost converter, or a charge pump converter, etc., but the present disclosure is not limited thereto. As used in this disclosure, the term “charge pump” refers to a switched-capacitor network configured to convert an input voltage (e.g., the regulated DC input voltage V1 in FIG. 11) to an output voltage (e.g., the output voltage V2 in FIG. 11). Examples of such charge pumps include cascade multiplier, Dickson, ladder, series-parallel, Fibonacci, and Doubler switched-capacitor networks, all of which may be configured as a multi-phase or a single-phase network. In addition, in the context of the present disclosure, power converting circuits that convert a higher input voltage power source to a lower output voltage level are commonly known as step-down or buck converters, because the converter is “bucking” the input voltage. Power converting circuits that convert a lower input voltage power source to a higher output voltage level are commonly known as step-up or boost converters, because the converter is “boosting” the input voltage. In addition, some power converters, commonly known as “buck-boost converters,” may be configured to convert the input voltage power source to the output voltage with a wide range, in which the output voltage may be either higher than or lower than the input voltage. In various embodiments, a power converter may be bidirectional, being either a step-up or a step-down converter depending on how a power source is connected to the converter.

As shown in the embodiments of FIG. 11, when the electrical device 1120 is connected to the charging device 1110, the controller 1116 can control the charging circuit 1112 and/or the programmable power supply circuit 1130 accordingly to operate in a target charging mode to charge the battery 1122 of the electrical device 1120, and dynamically switch between charging modes in response to various conditions and desired outcomes (e.g., fast high-power charging or slower but more efficient charging with less damage to the battery). For example, the memory 1162 may store a set of instructions, and one or more processors 1164 coupled to the memory 1162 may be configured to execute the set of instructions stored in the memory 1162 to cause the controller 1116 to perform operations of a method for controlling the charging circuit 1112 and/or the programmable power supply circuit 1130.

In some embodiments, the target charging mode can be selected from multiple charging mode candidates. FIG. 12 is a diagram 1200 illustrating charging characteristics of multiple charging mode candidates 1210-1270, in accordance with some embodiments of the present disclosure. As shown in FIG. 12, the charging mode candidates 1210-1270 may provide different charging power and charging efficiency. The battery charging optimization involves various trade-offs between several factors, such as charging time (e.g., speed or time it takes to charge the battery fully or to a certain percentage), power efficiency, battery temperature, etc. Generally speaking, as shown in the diagram 1200 of FIG. 12, a charging mode candidate 1210 with a slower charging speed (or a lower charging voltage) usually consumes less power and thus achieves higher power efficiency with the reduced power consumption, which also extends the long-term battery life. More specifically, slow charging generally provides higher energy efficiency when the battery is near empty, and as the battery reaches its full capacity, the energy consumption may become less efficient, regardless of the charging method used. On the other hand, a charging mode candidate 1220, which may be a fast-charging mode using a higher voltage (or power), enables the battery to charge faster and reduces the total charging time, but with lower power efficiency and possibly with a negative impact on long-term battery life/health. In view of the above, an optimized charging mode should be determined based on multiple factors, including the device type, battery capacity, current state of battery health, charging mode, personal usage patterns, etc. It is understood that the factors mentioned above are merely examples and not meant to limit the present disclosure. Charging mode candidates 1230, 1240, 1250, 1260, 1270 represent a number of different charging modes, which can be dynamically selected and realized.

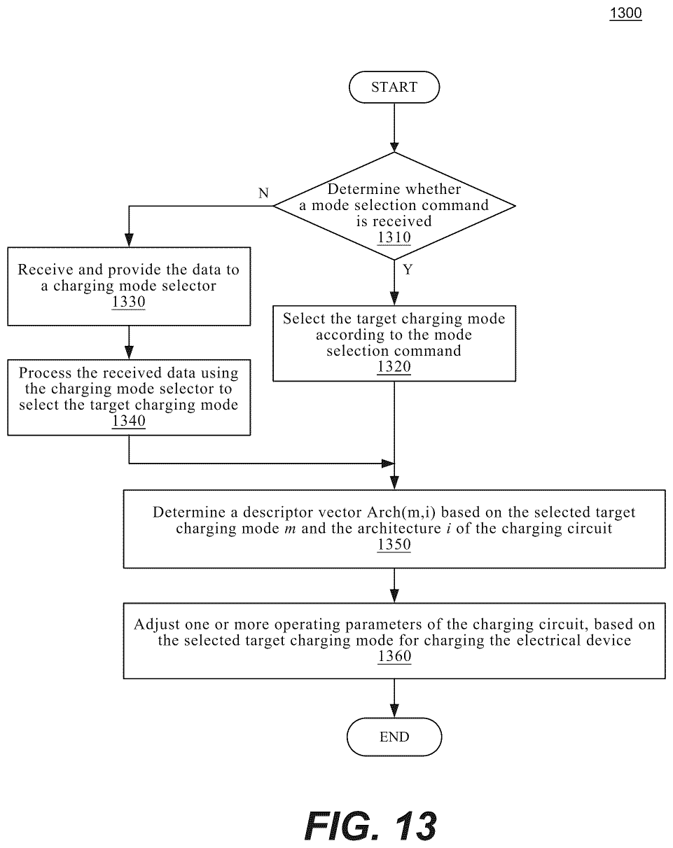

FIG. 13 is a flowchart of a method 1300 for controlling a charging circuit, in accordance with some embodiments of the present disclosure. It is understood that additional operations may be performed before, during, and/or after the method 1300 depicted in FIG. 13, and that some other processes may only be briefly described herein. The method 1300 can be performed by a controller, e.g., the controller 1116 illustrated in the embodiments of FIG. 11 above, but the present disclosure is not limited thereto.

As shown in FIG. 13, the method 1300 includes steps 1310-1360. In step 1310, the controller determines whether a mode selection command from a user is received. In response to a detection of the mode selection command from the user (step 1310—yes), in step 1320, the controller selects, from the charging mode candidates, the target charging mode according to the mode selection command. In other words, the user may manually select a desired charging mode (e.g., a fast-charge mode) for the electrical device (e.g., electrical device 1120 in FIG. 11). The corresponding mode selection command can be transmitted from the electrical device to the controller using various wired or wireless communication protocols. Based on the received mode selection command, the controller can control the charging process according to the user's preference. When the user selects another charging mode, the controller can adjust the charging operation dynamically in response to the updated mode selection command. Thus, the target charging mode can be changed during a single charging cycle of the battery in response to a manual selection.

In response to a determination that the mode selection command is not received from the user (step 1310—no), the controller may achieve an auto-adaptive charging by steps 1330 and 1340 to determine the target charging mode. In step 1330, the controller receives data from the electrical device to be charged, and provides the received data to a charging mode selector.

Specifically, the controller may receive battery information of the battery 1122 from the electrical device 1120 to be charged. For example, the battery information of the battery 1122 from the electrical device 1120 to be charged may include a battery state of charge (SOC), a battery state of health (SOH), a temperature of the battery 1122, or any combination thereof.

In addition, the controller may also receive one or more characteristic parameters from the electrical device 1120. The characteristic parameters may include various data associated with the electrical device 1120. For example, the characteristic parameters may include a device type (e.g., mobile devices, home appliances, electric vehicles, etc.), a use pattern of a user of the electrical device, location information, position information, time information, movement information, device temperature information, ambient temperature information (internal or external to the device), real-time power consumption information, real-time carbon emission information, historical power consumption information, or any combination thereof.

In some embodiments, the use pattern may be dependent on time of day or day of week, the user's location, etc. For example, a fast-charging mode may be selected for charging a user's mobile phone during working hours on a weekday or when the user commutes between the office and home, while a power-efficient mode may be selected during midnight hours or when the mobile phone is located at home, where the charging speed is likely not the most important factor. In various embodiments, the location information, the position information, the time information, and the movement information of the electrical device 1120 may be collected from corresponding internal sensors (e.g., Global Positioning System (GPS) sensors, inertial measurement units (IMUs), etc.) within the electrical device 1120, or retrieved from an external internet server.

In some embodiments, the device temperature information may be obtained from internal temperature sensors of the electrical device 1120 and include one or more of an average device temperature of the electrical device 1120, a maximum device temperature of the electrical device 1120, or a device skin temperature of the electrical device 1120, but the present disclosure is not limited thereto. In some embodiments, environmental information, such as the ambient temperature information, weather information, traffic information, may be obtained from external sensors or servers. It is noted that various characteristic parameters mentioned above are merely examples and not meant to limit the present disclosure.

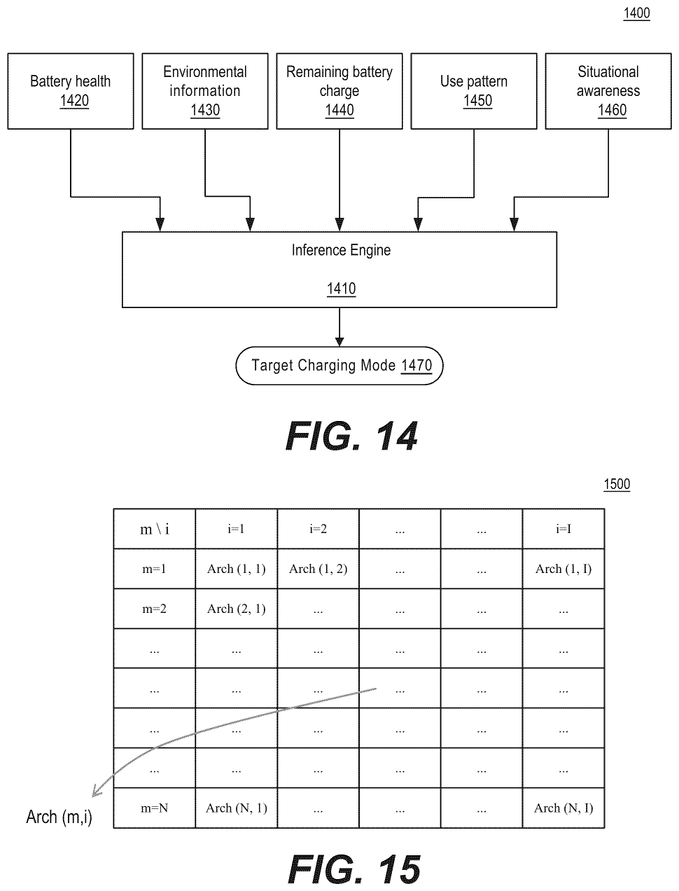

FIG. 14 is a diagram of an example charging mode selector 1400, in accordance with some embodiments of the present disclosure. As shown in FIG. 14, the charging mode selector 1400 may include an inference engine 1410. As shown in FIG. 14, the inference engine 1410 is configured to receive and process the battery information of the battery 1122 (e.g., battery health information (SOH) 1420 and remaining battery charge information (SOC) 1440) and characteristic parameters (e.g., environmental information 1430, use pattern information 1450, and situational awareness information 1460) from the electrical device 1120, and process the received data in order to output a selected target charging mode 1470 properly. For example, the environmental information 1430 may include real-time ambient temperature data collected by temperature sensor(s), and the situational awareness information 1460 may be real-time data collected and inferred based on inertial sensor(s). The use pattern information 1450 may be inferred by a machine learning model and dependent on the location of the electrical device 1120, the time of day, the day of week, etc.

The charging mode selector 1400 may be configured to select the target charging mode based on one or more received data, and set multiple rules. For example, the charging mode selector 1400 may select a first mode (e.g., a high-efficiency and low-power charging mode), in response to the received battery health information 1420 indicating a poor battery health/longevity. In another example, if the environmental information 1430 indicates that the date and time of the day coincide with a Flex Alert issued by the utility company, the charging mode selector 1400 may also select the first mode. If the user has already selected a fast-charge mode for the electrical device manually, the charging mode selector 1400 may also send an alert to notify the user and confirm with the user whether to switch from the fast-charge mode to a high-efficiency charging mode.

In addition, if the use pattern information 1450 indicates “an overnight sleep” scenario, and the situational awareness information 1460 indicates that the electrical device to be charged is not in motion, and the remaining battery charge information 1440 indicates that an estimated time to reach a predetermined percentage (e.g., 80%) of full charge of the battery is within the user's expected remaining sleep hours, the charging mode selector 1400 may also select the first mode (e.g., a high-efficiency and low-power charging mode), because in this situation fast-charging is unnecessary. On the other hand, if the remaining battery charge information 1440 indicates that an estimated time to reach the predetermined percentage (e.g., 80%) of full charge of the battery exceeds the user's expected remaining sleep hours, the charging mode selector 1400 may select different fast-charging modes to accelerate the charging. In some embodiments, the fast-charging mode can be selected according to the difference (or ratio) between the estimated time to reach the predetermined percentage and the expected remaining sleep hours.

Referring again to FIG. 13, by the operations above, after the battery information and the one or more characteristic parameters are obtained, in step 1340 of the method 1300, the controller may process the received data using the charging mode selector 1400, and select, from the charging mode candidates, the target charging mode according to the battery information and the one or more characteristic parameters. It would be appreciated that the above example rules and settings are not meant to limit the present disclosure. In various embodiments, the charging mode selector 1400 may apply various different preset rules or customized rules created by the user to determine the target charging mode.

Accordingly, with the operations of steps 1310-1340, the target charging mode can be selected, either manually by the user or automatically based on the received data. In addition, in response to updated commands from the user or updated characteristic parameters and/or battery information received from the electronic device to be charged, the controller may dynamically change the target charging mode during a charging cycle of the battery by repeating steps 1310-1340.

Then, in step 1350, the controller may determine operating parameters for operating the charging circuit (e.g., charging circuit 1112 in FIG. 11) according to the selected target charging mode and an architecture of the charging circuit. In some embodiments, the operating parameters may be represented by an architecture and operation descriptor vector Arch (m,i), which is a descriptor vector for power delivery (PD) and battery charging. The descriptor vector components include the values of the operating parameters for the ith architecture (1<i≤I) for realizing the target charging mode m (1<m≤M), where I and M denote the total number of available circuit architectures and the total number of available target modes, respectively. Specifically, in step 1350, the controller may retrieve a corresponding target set of the operating parameters selected from multiple candidate sets of the operating parameters stored in a memory, e.g., through a lookup operation as described in the below, according to the target charging mode and the architecture of the charging circuit.

Then, in step 1360, the controller may adjust one or more operating parameters of the charging circuit, based on the selected target charging mode for charging the electrical device 1120. For example, the controller 1116 may provide corresponding commands to the charging circuit 1112 or the programmable power supply circuit 1130, according to the descriptor vector Arch (m,i) and the corresponding target set of the operating parameters.

FIG. 15 is a diagram illustrating an example lookup table (LUT) 1500 containing the candidate sets of the operating parameters stored in a memory for the method 1300 in FIG. 13, in accordance with some embodiments of the present disclosure. As shown in FIG. 15, each row of the lookup table 1500 represents a corresponding charging mode m and each column of the lookup table 1500 represents a corresponding architecture i of the charging circuit. The corresponding cell of the m-th row, and i-th column contains the descriptor vector Arch (m,i) denoting the target set of the operating parameters for the ith circuit architecture when it is operating in charging mode m, in which i is an index of the architecture, and m is an index of the charging mode. The components of the vector Arch (m,i) are the values of the set of parameters p(m,i,j) specific to the i-th architecture operating in the m-th charging mode, in which j is an index of the operation parameter. An example vector Arch (m,i) may be expressed using the following equation:

$$Arch ( m , i ) = {[ p ( m , i , 1 ) ; p ( m , i , 2 , {DC}_{1} ) ; … p ( m , i , 2 , {DC}_{K} ) ; \\ p ( m , i , 3 , {S}_{1} ) ; … ; p ( m , i , 3 , {S}_{P} ) ; … ; p ( m , i , J , d ) ]}^{T}$$

In the above equation, p(m,i,j) denotes the j-th operation parameter, DCₖ denotes the k-th dc-dc converter of the total K dc-dc converters in the charging circuit 1112, and Sₚ denotes the p-th bypass switch of the total P switches in the charging circuit 1112, where 1≤j≤J, 1≤k≤K, and 1≤p≤P. The values of J, K, and P determine the total dimension of the vector Arch (m,i).

The operation parameters p(m,i,j) are associated with one or more of a voltage level of a supply voltage (e.g., voltage V1) outputted by an adjustable voltage source (AVS) in the programmable power supply circuit 1130, an architecture of the charging circuit 1112, or a power flow direction of one or more power converters in the charging circuit 1112.

In some embodiments, the first operation parameter p(m,i,1) may be used to describe a voltage value or a voltage range of the AVS supply voltage. For example, the parameter p(m,i,1) can be a real number and quantized to a finite set of values (e.g., a set of q values: p(m,i,1)₁, p(m,i,1)₂, . . . ,p(m,i,1)_{q}) corresponding to different voltage levels (e.g., 5V, 12V, 15V, 18V, 24V, 36V, 48V, 60V, etc.). In some embodiments, one or more second operation parameters p(m,i,2, DCₖ) may be used to denote corresponding Enable/Disable flags for the k-th dc-dc converter DCₖ in the charging circuit 1112. For example, the parameter p(m,i,2,DCₖ) being true (e.g., “1”) indicates that the k-th dc-dc converter DCₖ in the charging circuit 1112 is enabled or active, while the parameter p(m,i,2,DCₖ) being false (e.g., “0”) indicates that the k-th dc-dc converter DCₖ in the charging circuit 1112 is disabled or inactive. In some embodiments, one or more third operation parameters p(m,i,3,Sₚ) may be used to denote corresponding Close/Open flags for the p-th bypass switch Sₚ in the charging circuit 1112. For example, the parameter p(m,i,3,Sₚ) being true (e.g., “1”) indicates that the p-th bypass switch Sₚ in the charging circuit 1112 is closed, while the parameter p(m,i,3,Sₚ) being false (e.g., “0”) indicates that the p-th bypass switch Sₚ in the charging circuit 1112 is open.

In some embodiments, a fourth operation parameter p(m,i,J,d) may be used to denote a power flow direction of the operation of the power converter(s) in the charging circuit 1112. The parameter p(m,i,J,d) may be a binary value, in which the parameter p(m,i,J,d) may be a first value (e.g., “1”) indicating a forward direction of the power flow or a second value (e.g., “0”) indicating a backward direction of the power flow.

For example, a charging circuit 1112 having two dc-dc converters and three bypass switches, may have a 7×1 vector Arch (m,i). If the components of the vector Arch (m,i) are [15; 1; 0; 1; 1; 0; 1]^{T}, the operation parameters indicate that when the i-th architecture operates in the m-th charging mode, the supply voltage outputted by the adjustable voltage source (AVS) is configured to 15 volts, the first dc-dc converter is configured to be active and the second dc-dc converter is configured to be inactive, the first and the second bypass switches are closed, and the third bypass switch is open, and the power converter operates in the forward direction.

Values of each candidate set represented by the descriptor vector Arch (m,i) and associated with the corresponding architecture i and the corresponding charging mode candidate m can be obtained by a processor. For example, the processor may obtain each candidate set by applying a neural network to process multiple input parameters. In various embodiments, the neural network may be implemented in different ways. For example, the neural network may be a perceptron network, a classifier network, an optimization network, or any combination thereof. In some embodiments, the neural network is configured to perform a regression between a set of the operating parameters and a corresponding charging efficiency or a corresponding charging power or time to reach a percentage of full charge of a battery, which will be discussed in more details later.

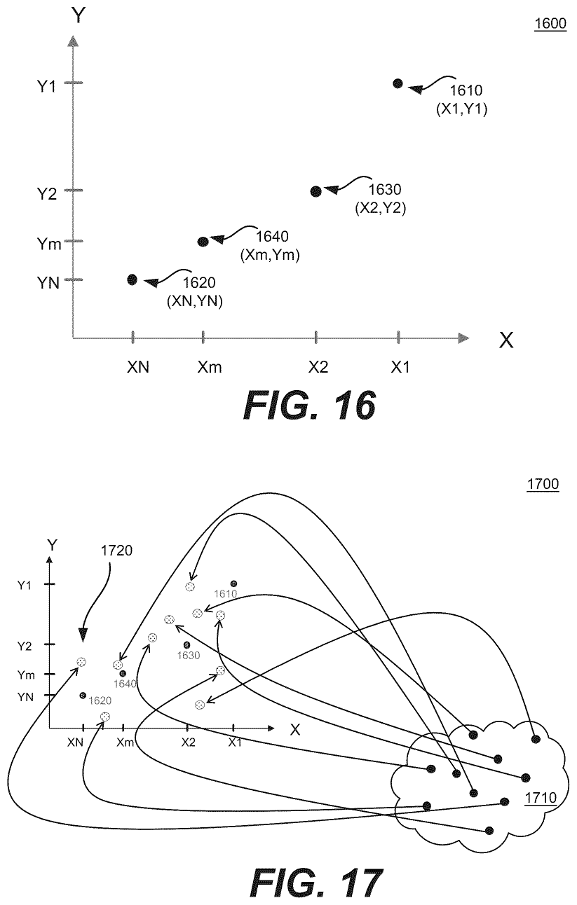

FIG. 16 is a diagram illustrating a performance plane 1600 for the charging modes corresponding to the i-th architecture for the method 1300 in FIG. 13, in accordance with some embodiments of the present disclosure. In the performance plane 1600, the x-axis represents the charging time required to full charge, and the y-axis represents the charging efficiency. The coordinate pair (Xm, Ym) of a point defines the corresponding charging characteristics set for the m-th charging mode. In some embodiments, the charging time required to full charge (i.e., Xm) may change in time as the battery health drops. For example, in the X-Y performance plane 1600, a point 1610 at (X1, Y1) may represent the first charging mode providing the highest charging efficiency, a point 1620 at (XN, YN) may represent the second charging mode providing the shortest charging time required. Points 1630 and 1640 may represent other intermediate modes providing different charging characteristics.

The parameters (e.g., components of the vector Arch (m,i)) for the i-th architecture that will result in the coordinate pair (Xm, Ym) describing a target charging mode, mode m 1640, can be determined by processing an input vector through neural network. The input vector may contain multiple input parameters for the neural network. In some embodiments, the input parameters for the neural network may include the target charging mode, the architecture of the charging circuit, ambient temperature, and the battery information, etc. For example, the input vector may be expressed as: [(Xm, Ym); i; M₁ . . . M_{W}]^{T}, in which M₁ to M_{W} are measured quantities, such as the ambient temperature and the battery information that impact the efficiency of the power delivery and the battery charging circuit. The neural network may output, in response to the received input vector, the descriptor vector Arch (m,i) as an output vector.

In some embodiments, different neural network models may be used for different temperature values. The actual measured temperature value can be quantized to a finite set of temperature values corresponding to the neural network models. In other words, the neural network model can be trained for different temperatures in the set of temperature values, and the neural network parameters may be temperature dependent. In some other embodiments, the neural network parameters may also be dependent on the battery information (e.g., the battery age), which can be quantified by the number of charging cycles performed on the battery.

FIG. 17 is a diagram illustrating a mapping 1700 between a training set 1710 of Arch (m,i) vectors (e.g., within a J dimensional vector space) and a corresponding resultant set 1720 of values on the 2-dimensional performance plane, in accordance with some embodiments of the present disclosure. The training set 1710 may be a multiple dimensional vector space (e.g., a 7-dimensional vector space) of the vectors Arch (m,i). As shown in FIG. 17, the mapping between pairs from the training set 1710 and the resultant set 1720 are used to determine neural network parameters. Alternatively stated, the neural network may learn from the training set 1710 and the resultant set 1720 to obtain neural network parameters that define the “fitting” between the training set 1710 and the resultant set 1720, or the regression from the resultant set 1720 to the training set 1710 or from the training set 1710 to the resultant set 1720. After the neural network is trained, then the neural network may produce a predicted vector Arch (m,i) for the given specific input coordinate pair (Xm, Ym) for a target charging mode. Note that the target modes, 1610, 1620, 1630, 1640, on the X-Y performance plane, may not coincide with the resultant set 1720 as shown in FIG. 17. In some embodiments, the neural network may be a multi-layer perceptron (MLP) network and may be trained using methods such as back propagation.

As mentioned above, the neural network may be a classifier network. Specifically, a classifier network is configured to classify the input vector to a set of U classes, which are defined based on a predetermined finite set of values for the components of Arch (m,i) and their combinations. As explained above, the first operation parameter p(m,i, 1) may be quantized to a finite set of q distinct values. Remaining operation parameters p(m,i,2, DCₖ) and p(m,i,3, Sₚ) and p(m,i,J,d) are binary by definition. For a specific architecture (e.g., the i-th architecture), a classifier network may be trained using a finite size training data set containing a set of specific Arch (m,i) vectors and their corresponding resultant coordinate pairs (Xm, Ym) using supervised learning. After the training, when fed by a desired target charging mode and the corresponding coordinate pair (Xm, Ym) in operation, the network will produce specific values for the Arch (m,i) vector as the result of classification. In some embodiments, the classifier network may be a perceptron network and trained using various methods, such as back propagation. For example, the neural network may be a multi-layer perceptron (MLP).

In some embodiments, the neural network may also be an optimization network, which is configured to determine its network states that maximizes/optimizes the value of a certain objective function expressed in terms of values of the neural network parameters, such as node-to-node interconnection weights and node nonlinearities (activation function), and states of the network nodes that correlate to the components of the output vector Arch (m,i).

The network objective function may be defined in terms of the efficiency of the power delivery and charging circuit for the particular i-th architecture. The network iterates (or updates) the values of the states of its nodes according to a recursion specific to a specific network (e.g., a Hopfield network). Iterations converge to states that maximize the network objective function. In other words, the network objective function iteratively reaches its local or global minimum. The states (i.e., the output vector) are then used as the architecture parameters when the maximum efficiency mode (e.g., the first charging mode at the point 1610 in FIG. 16) is desired. In some embodiments, the network can be a Hopfield network with its specific objective function (or “energy function”) defined in a way that relates to the circuit efficiency. States of network nodes correspond to components of the output vector Arch (m,i). For example, the node-to-node interconnection weights can be determined by the training based on back propagation.

Thus, by training the neural network and using the trained neural network to obtain components of each vector Arch (m,i) associated with the corresponding architecture and charging mode, the controller may adjust the charging efficiency or the charging power or time to reach a percentage of full charge of the battery 1122 by adjusting the corresponding operating parameter(s) in step 1360 of the method 1300.

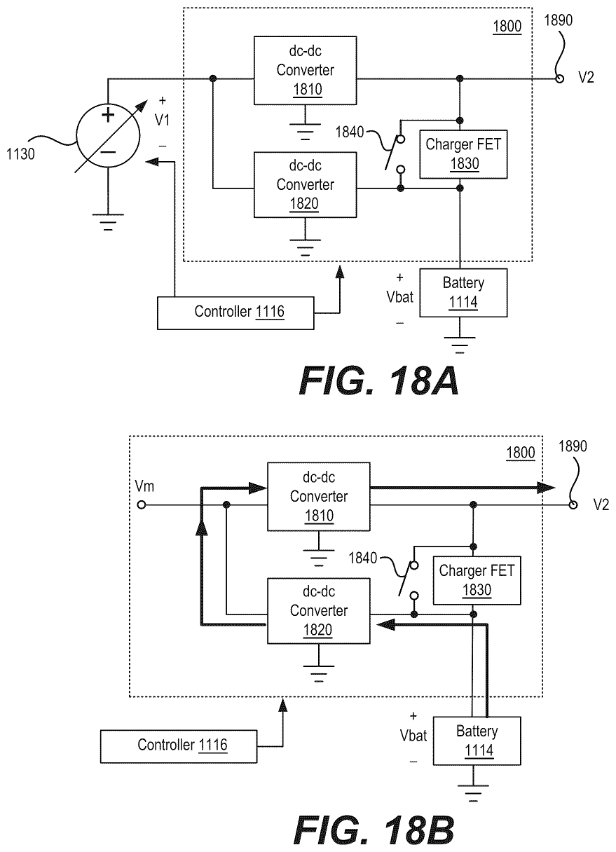

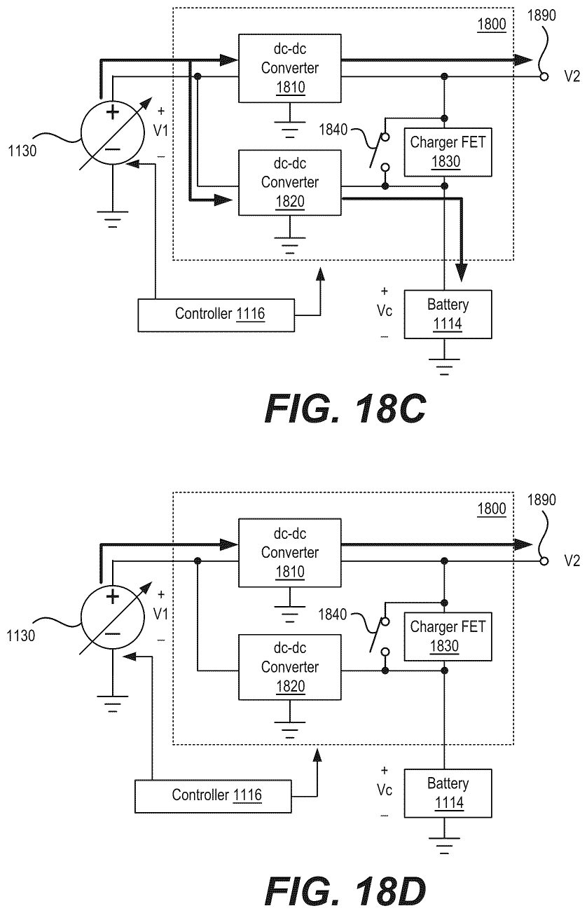

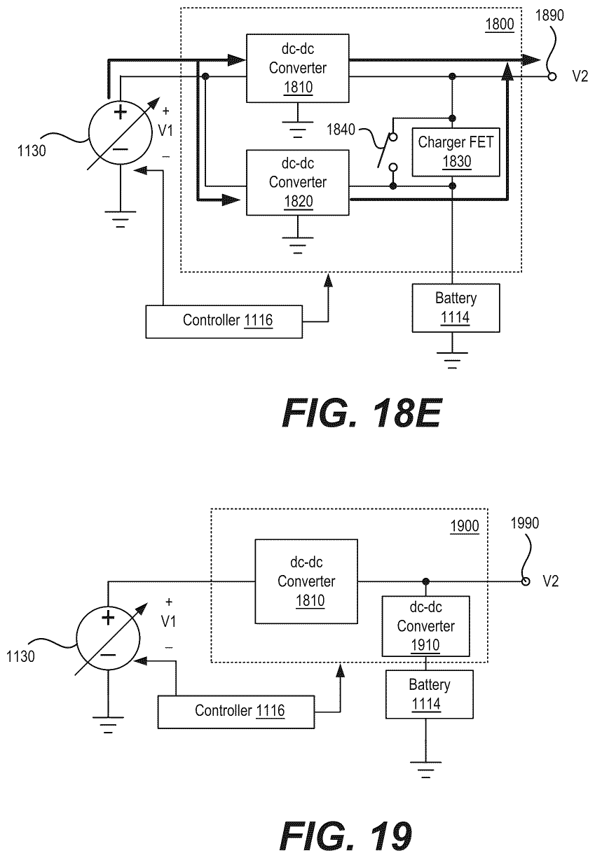

FIG. 18A is a block diagram of an example charging circuit 1800, in accordance with some embodiments of the present disclosure. FIG. 18B to FIG. 18E illustrate example charging modes and corresponding power flows in the charging circuit of FIG. 18A, in accordance with some embodiments of the present disclosure. In the architecture shown in FIG. 18A to FIG. 18E, the charging circuit 1800 includes dc-dc converters 1810, 1820, a charger transistor 1830 and a switch device 1840 electrically coupled in parallel to the charger transistor 1830. The battery 1114 is electrically coupled to the dc-dc converter 1820. Specifically, the charging circuit 1800 is electrically coupled to the programmable power supply circuit 1130, which can be an Adjustable Voltage Source (AVS) and configured to provide a regulated DC input voltage V1. The voltage level of the regulated DC input voltage V1 can be dynamically adjusted by the programmable power supply circuit 1130, in response to corresponding commands from the controller 1116, which has been discussed in the embodiments of FIG. 11 above and thus details are not repeated herein for the sake of brevity.

In some embodiments, the dc-dc converter 1810 may be a buck converter, a boost converter, or a charge pump converter, etc., but the present disclosure is not limited thereto. As used in this disclosure, the term “charge pump” refers to a switched-capacitor network configured to convert an input voltage (e.g., the regulated DC input voltage V1) to an output voltage (e.g., the output voltage V2). Examples of such charge pumps include cascade multiplier, Dickson, ladder, series-parallel, Fibonacci, and Doubler switched-capacitor networks, all of which may be configured as a multi-phase or a single-phase network. In addition, in the context of the present disclosure, power converting circuits that convert a higher input voltage power source to a lower output voltage level are commonly known as step-down or buck converters, because the converter is “bucking” the input voltage. Power converting circuits that convert a lower input voltage power source to a higher output voltage level are commonly known as step-up or boost converters, because the converter is “boosting” the input voltage. In addition, some power converters, commonly known as “buck-boost converters,” may be configured to convert the input voltage power source to the output voltage with a wide range, in which the output voltage may be either higher than or lower than the input voltage. In various embodiments, a power converter may be bidirectional, being either a step-up or a step-down converter depending on how a power source is connected to the converter.

As shown in FIG. 18A, the dc-dc converter 1810 is electrically coupled to the programmable power supply circuit 1130 and configured to convert the regulated DC input voltage V1 to the output voltage V2 at the output node 1890 of the charging circuit 1800. The battery 1114 is configured to be charged or discharged, directly or indirectly via the output node 1890. The dc-dc converter 1820 is electrically coupled in series between the programmable power supply circuit 1130 and the battery 1114. The charger transistor 1830 is electrically coupled between the dc-dc converter 1810 and the dc-dc converter 1820. In some embodiments, the dc-dc converter 1810 and the dc-dc converter 1820 may be configured to operate simultaneously.

In some embodiments, in step 1360, the controller may selectively control a voltage level of the supply voltage (e.g., regulated DC input voltage V1) outputted by the programmable power supply circuit 1130, based on the selected target charging mode. Accordingly, the output voltage V2 at the output node 1890 is controlled at a desired level corresponding to the target charging mode. For example, in the first charging mode (e.g., point 1610 in FIG. 16) providing a high charging efficiency using a low power output, the voltage V1 can be lowered such that the de-de converter 1810 is highly efficient with a small transformation ratio. The first charging mode may offer about 5-10% efficiency improvement, and reduction in net carbon emissions, which is suitable for use cases where the charging time is a less important factor, such as charging at bedtime. In the second charging mode (e.g., point 1620 in FIG. 16) providing a short charging time required using a high-power output, the voltage V1 can be increased, with the dc-dc converter 1810 operating with a relatively large transformation ratio. The second charging mode may offer faster charging and allow the user to use the device with less waiting time, which is suitable for time sensitive use cases, such as gaming, phone charging before work, etc. In other intermediate charging modes (e.g., points 1630, 1640 in FIG. 16), the voltage V1 can be dynamically increased or decreased, based on detected conditions and/or user selection.

In some embodiments, in step 1360, the controller may selectively enable or disable one or more power converters in the charging circuit based on the selected target charging mode. For example, in some charging modes, the de-dc converter 1820 may be disabled when a single dc-dc converter 1810 is sufficient to perform the power conversion in the target charging mode.

In some embodiments, in step 1360, the controller may selectively control a power flow direction of one or more de-de converters 1810 and 1820, based on the selected target charging mode. For example, in response to a first charging mode being selected, the controller may control a target power converter to receive an input power from a first end and provide an output power through a second end. In response to a second charging mode being selected, the controller may control the target power converter to receive the input power from the second end and provide the output power through the first end. In response to a third charging mode being selected, the controller may disable the target power converter to stop power from flowing through the target power converter.

For example, FIG. 18B illustrates an example charging mode and the power flow during a discharging phase of the battery 1114 in the charging circuit 1800 of FIG. 18A, in accordance with some embodiments of the present disclosure. As shown in FIG. 18B, in the discharging phase of the battery 1114, the dc-dc converter 1820 may be configured to convert the battery voltage Vbat outputted by the battery 1114 to a first voltage (e.g., the voltage Vm) received by the dc-dc converter 1810. The dc-dc converter 1810 is configured to regulate and provide the output voltage V2, in response to the first voltage (e.g., the voltage Vm) from the dc-dc converter 1820. Accordingly, in response to the charging mode of FIG. 18B being selected, the controller may control a target power converter (e.g., dc-dc converter 1820) to receive an input power from a first end and provide an output power through a second end.

For example, FIG. 18C illustrates another example charging mode and the power flow during a charging phase of the battery 1114 in the charging circuit 1800 of FIG. 18A, in accordance with some embodiments of the present disclosure. As shown in FIG. 18C, in the charging phase of the battery 1114, the dc-dc converter 1810 is configured to provide the output voltage V2, in response to the regulated DC input voltage V1 from the programmable power supply circuit 1130. The de-dc converter 1820 is configured to provide a charging voltage Vc to the battery 1114, in response to the regulated DC input voltage V1 from the programmable power supply circuit 1130. Accordingly, in response to the charging mode of FIG. 18C being selected, the controller may control the target power converter (e.g., dc-dc converter 1820) to receive the input power from the second end and provide the output power through the first end.

For example, FIG. 18D illustrates another example charging mode and the power flow in the charging circuit 1800 of FIG. 18A, in accordance with some embodiments of the present disclosure. For example, the charging mode of FIG. 18D may be the first charging mode (e.g., point 1610 in FIG. 16). As shown in FIG. 18D, the voltage V1 can be lowered, and the dc-dc converter 1810 is configured to provide the output voltage V2, in response to the regulated DC input voltage V1 from the programmable power supply circuit 1130. The controller may further disable the target power converter (e.g., the dc-dc converter 1820) to stop power from flowing through the target power converter, in response to the charging mode of FIG. 18D being selected.

For example, FIG. 18E illustrates another example charging mode and the power flow in the charging circuit 1800 of FIG. 18A, in accordance with some embodiments of the present disclosure. For example, the charging mode of FIG. 18E may be the second charging mode (e.g., point 1620 in FIG. 16). As shown in FIG. 18E, the voltage V1 can be increased, and the dc-dc converters 1810 and 1820 are both enabled to allow greater power flowing through the charging circuit 1800 to provide the output voltage V2, in response to the regulated DC input voltage V1 from the programmable power supply circuit 1130.

In some other embodiments, in step 1360, the controller may selectively enable or disable one or more switch devices (e.g., switch device 1840) to bypass a charger transistor (e.g., charger transistor 1830), based on the selected target charging mode. For example, in one or more intermediate charging modes (e.g., points 1630, 1640 in FIG. 16), the switch device 1840. In addition, in one or more intermediate charging modes, the controller may also selectively operate a target power converter (e.g., dc-dc converter 1820) in a forward direction or a backward direction in response to the required output voltage V2 for the selected target charging mode. Examples are provided in the above embodiments of FIG. 18B and FIG. 18C, and thus details are omitted herein for the sake of brevity.

It is noted that, in various embodiments, different converter types can be applied to implement a high-efficient converter for the de-de converter 1820. For example, the dc-dc converter 1820 may be a magnetic-based unregulated converter, an LLC converter, a switched-capacitor (SC)-based converter, etc. In some embodiments, one of the de-de converter 1810 and the dc-dc converter 1820 can be an unregulated converter, and the other one of the dc-dc converter 1810 and the dc-dc converter 1820 can be a regulated converter. During the discharging phase of the battery 1114, the output voltage V2 can be regulated by the regulated converter. During the charging phase of the battery 1114, the output voltage V2 and the charging voltage Vc can be regulated by the regulated converter and the programmable power supply circuit 1130 providing the regulated DC input voltage V1.

For example, if the dc-dc converter 1810 is an unregulated converter, then during the discharging phase of the battery 1114 shown in FIG. 18B, the output voltage V2 can be indirectly controlled and regulated by the dc-dc converter 820 providing a regulated voltage Vm. During the charging phase of the battery 1114 shown in FIG. 18C, the output voltage V2 can be indirectly controlled and regulated by the programmable power supply circuit 1130 providing the regulated DC input voltage V1, and the charging voltage Vc can be regulated by the de-de converter 1820.

In another example, if the dc-dc converter 1820 is an unregulated converter, then during the discharging phase of the battery 1114 shown in FIG. 18B, the output voltage V2 can be controlled and regulated by the dc-dc converter 1810 outputting the output voltage V2. During the charging phase of the battery 1114 shown in FIG. 18C, the charging voltage Vc can be indirectly controlled and regulated by the programmable power supply circuit 1130 providing the regulated DC input voltage V1, and the output voltage V2 can be regulated by the dc-dc converter 1810. The embodiments of FIGS. 18A-18D can achieve a flash charging mechanism by using one regulating converter and one high-efficiency unregulated converter to provide the output voltage V2 at a high voltage (HV) level and provide the charging voltage Vc at a desired level for the battery 1114. By running the dc-dc converter 1810 and the dc-dc converter 1820 simultaneously, the overall power efficiency can be improved. In some embodiments, different charging/discharging modes can be achieved by selecting the dc-dc converter(s) 1810 or 1820 to be enabled or disabled.

In addition to the architecture shown in FIG. 18A-FIG. 18E, the controller may also adjust the operation parameters for other architectures in response to the selected target charging mode. In the following paragraphs, other possible architectures of the charging circuit in the charging device will be discussed in accompany with FIG. 19 to FIG. 25, but the present disclosure is not limited thereto.

FIG. 19 is a block diagram of another example charging circuit 1900, in accordance with some embodiments of the present disclosure. In the architecture shown in FIG. 19, the charging circuit 1900 includes de-de converters 1810 and 1910. In some embodiments, the de-dc converter 1910 can be viewed as a bidirectional buck converter to provide the system voltage (e.g., output voltage V2). In some other embodiments, the dc-dc converter 1910 can be viewed as a bidirectional boost converter for the battery 1114 to be charged or discharged via an output node 1990. The battery 1114 is electrically coupled to the dc-dc converter 1910. The de-de converter 1910 is electrically coupled between the battery 1114 and the output node 1990 providing the output voltage V2. In some embodiments, the dc-dc converter 1910 may be a boost converter or a charge pump converter providing a fixed offset between the battery voltage of the battery 1114 and the output voltage V2. Similar to the embodiments above, the dc-dc converter 1810 is electrically coupled to the programmable power supply circuit 1130 and configured to convert the regulated DC input voltage V1 to the output voltage V2 at the output node 1990. The battery 1114 is configured to be charged or discharged, directly or indirectly via the output node 1990.

Accordingly, the charging circuit 1900 provides a charging mechanism, in which a single dc-dc converter 1810 is configured to convert the regulated DC input voltage V1 to the output voltage V2, and the output voltage V2 can be used to charge the battery 1114 and to provide the system voltage required by the circuits or devices in a next power stage connecting to the output node 1990. When the programmable power supply circuit 1130 is the power source, the charging circuit 1900 receives the regulated DC input voltage V1 from the programmable power supply circuit 1130 as the input voltage, with a proper voltage level controlled and regulated by the programmable power supply circuit 1130. When the battery 1114 is the power source, the dc-dc converter 1910 may be configured to provide the output voltage V2 accordingly. Thus, the voltage range of the output voltage V2 can be narrower and within a desired voltage range. For example, in some embodiments, the output voltage V2 may be in the range of about 9V-5V for a 2S cell (i.e., 2 battery cells connected in series) application in a Narrow Voltage DC (NVDC) Architecture. In addition, the architecture shown in FIG. 19 also provides more flexibility for the regulation of the input voltage of the dc-dc converter 1810 to maximize the power efficiency. Because the output voltage V2 may be indirectly controlled and regulated according to the regulated DC input voltage V1, the dc-dc converter 1810 may be an unregulated converter with high efficiency. Accordingly, the switching loss can be reduced, and the overall efficiency can be improved.

FIG. 20 is a block diagram of another example charging circuit 2000, in accordance with some embodiments of the present disclosure. Compared to the charging circuit 1900 of FIG. 19, the charging circuit 2000 further includes a charger transistor 1830 and a switch device 1840 electrically coupled in parallel to the charger transistor 1830. As shown in FIG. 20, the charger transistor 1830 is electrically coupled in series between the de-dc converter 1810 and the battery 1114 via an output node 2090. The charger transistor 1830 is configured to enable or disable charging or discharging of the battery 1114. For example, when the battery 1114 is fully charged, the charger transistor 1830 can be controlled in response to a corresponding control command from the controller 1116 to disable the charging of the battery 1114 by disconnecting the battery 1114 from the de-de converter 1810. On the other hand, when the battery 1114 needs to be charged, the charger transistor 1830 can be controlled in response to a corresponding control command from the controller 1116 to enable the charging of the battery 1114 based on the output voltage V2 outputted from the dc-dc converter 1810.

Similarly, when the charging circuit 2000 receives the regulated DC input voltage V1 and performs the power conversion to provide the output voltage V2 based on the regulated DC input voltage V1, the charger transistor 1830 can be controlled in response to a corresponding control command from the controller 1116 to disable the discharging of the battery 1114 by disconnecting the battery 1114 from the output node 2090. On the other hand, when the battery 1114 needs to output the output voltage V2 for the next stage, the charger transistor 1830 can be controlled in response to a corresponding control command from the controller 1116 to discharge the battery 1114 at the desired power level. Accordingly, a charging mechanism can be achieved by using an adjustable voltage source (e.g., the regulated DC input voltage V1 from the programmable power supply circuit 1130) to replace a fixed voltage source to provide the output voltage V2 and provide power to charge the battery 1114.

In some embodiments, the switch device 1840 is an optional switching element. The switch device 1840 in parallel to the charger transistor 1830 is configured to bypass the charger transistor 1830 when the switch device 1840 is closed. Specifically, the switch device 1840 can be controlled and used to bypass the charger transistor 1830 in response to the selected charging mode when applicable and provide a less resistive power path between the battery 1114 and the output node 2090. Accordingly, the overall power efficiency can be improved. For example, when the programmable power supply circuit 1130 is used at the power source, the charging circuit 2000 may receive the regulated DC input voltage V1 to provide a high-efficiency output voltage V2. During a Constant Current (CC) mode, the switch device 1840 may be enabled to bypass the charger transistor 1830. In addition, when the battery 1114 is used at the power source, the switch device 1840 may also be enabled to bypass the charger transistor 1830, so that the battery 1114 can provide the output voltage V2 directly to the output node 2090. The circuit shown in FIG. 20 is an example and not meant to limit the present disclosure. For example, similar to the embodiments of FIG. 19, the charging circuit 2000 may further include another boost converter or charge pump converter providing a fixed offset between the battery voltage Vbat of the battery 1114 and the output voltage V2 to ensure that the output voltage V2 does not reach or exceed the battery voltage Vbat. In some embodiments, the charging path including the charger transistor 1830 can thus be removed accordingly.

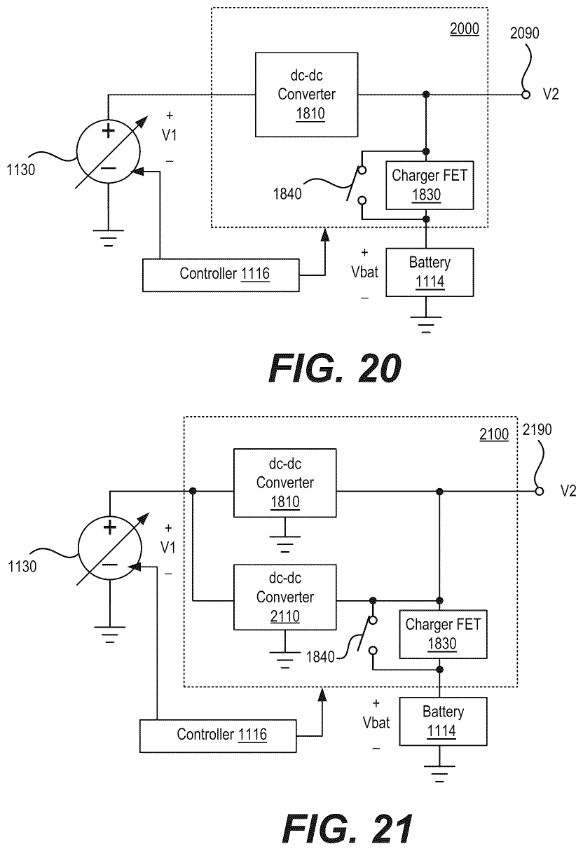

FIG. 21 is a block diagram of another example charging circuit 2100, in accordance with some embodiments of the present disclosure. Compared to the charging circuit 1800 of FIG. 18A-FIG. 18E, the charging circuit 2100 also includes another de-dc converter 2110, and the dc-dc converter 1810 and the de-de converter 2110 are electrically coupled in parallel.

In some embodiments, the dc-dc converter 1810 and the de-dc converter 2110 operate at the same conversion ratio. In some embodiments, one of the de-de converter 2110 and the dc-dc converter 1810 may be unregulated. By arranging the dc-dc converter 2110 and the de-de converter 1810 in parallel, the power path providing the output voltage V2 at the output node 2190 or the charging voltage to the battery 1114 can be optimized with the dc-dc converter 2110 and the dc-dc converter 1810 operating together to provide additional power.

Similar to the charging circuit 1800, in some embodiments, the switch device 1840 is electrically coupled in parallel to the charger transistor 1830. In a charging phase of the battery 1114, the switch device 1840 is closed to bypass the charger transistor 1830 to achieve high-efficiency charging to the battery 1114. In a discharging phase of the battery 1114, the switch device 1840 is closed to bypass the charger transistor 1830 to provide the output voltage V2 from the battery 1114. Thus, when the power is drawn from the battery 1114, the output voltage V2 may be the battery voltage Vbat, instead of a reduced voltage due to the voltage drop across the charger transistor 1830.

The charging circuits shown in FIGS. 18A-18E and FIG. 21 are examples and not meant to limit the present disclosure. For example, similar to the above embodiments, the charging circuit 1800 or 2100 may further include another boost converter or charge pump converter providing a fixed offset between the battery voltage Vbat of the battery 1114 and the output voltage V2 to ensure that the output voltage V2 does not reach or exceed the battery voltage Vbat, and is at a specific level (e.g., 5V). In some embodiments, the charging path including the charger transistor 1830 can thus be removed accordingly.

In the above embodiments of FIGS. 18A-18E to FIG. 21, the programmable power supply circuit 1130 can be used as an adjustable and dynamic input voltage source to replace the fixed input voltage source in the traditional design. The programmable power supply circuit 1130 can be applied to maximize the power efficiency by regulating the input voltage of the de-de converter(s). In some embodiments, the battery 1114 can be connected to a boost converter or a charge pump converter for outputting a regulated output voltage V2. Accordingly, the voltage range of the output voltage V2 can be narrower. In some embodiments, a fixed offset between the battery voltage Vbat of the battery 1114 and the output voltage V2 can be ensured.

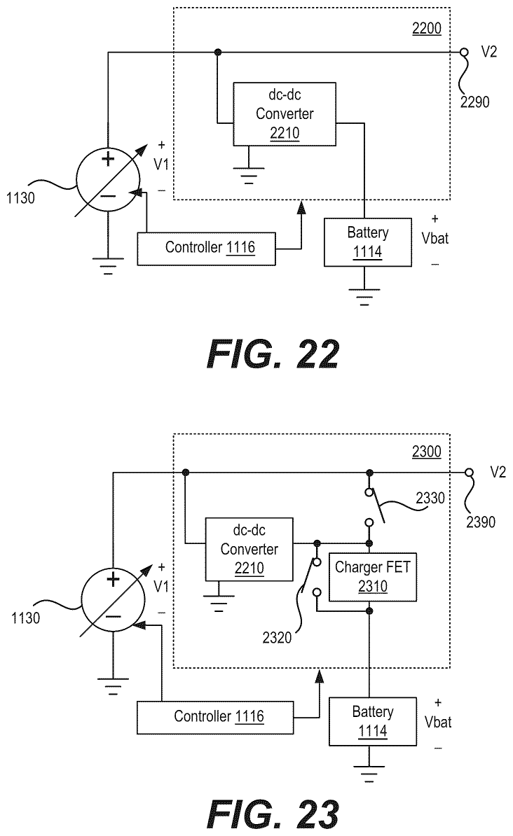

FIG. 22 is a block diagram of another example charging circuit 2200, in accordance with some embodiments of the present disclosure. Compared to the above embodiments, the charging circuit 2200 is designed for a Wide Voltage DC (WVDC) architecture. The charging circuit 2200 may be configured to provide the output voltage V2 with a wider voltage range compared to NVDC architectures in the above embodiments. In some embodiments, in the WVDC architecture, the output voltage V2 may be in the voltage range of about 20V-5V, which is broader than the voltage range of about 9V-5V for an example NVDC architecture, but the present disclosure is not limited thereto.

As shown in FIG. 22, the charging circuit 2200 includes a dc-dc converter 2210. The battery 1114 is electrically coupled to the dc-dc converter 2210. Specifically, the charging circuit 2200 is electrically coupled to a programmable power supply circuit 1130. Similar to the embodiments above, the programmable power supply circuit 1130 can be an Adjustable Voltage Source (AVS). The programmable power supply circuit 1130 is configured to provide the regulated DC voltage V1 as an output voltage V2 at an output node 2290 of the charging circuit 2200 to the next stage.

The dc-dc converter 2210 is electrically coupled to the programmable power supply circuit 1130 at the output node 2290 and is configured to perform a voltage conversion between the output voltage V2 and a battery voltage Vbat of the battery 1114. The battery 1114 is electrically coupled to the dc-dc converter 2210 and configured to be charged or discharged, directly or indirectly, based on the battery voltage Vbat.

The charging circuit 2200 provides a charging mechanism without arranging a charger transistor in the charging circuit 2200. In some embodiments, the dc-dc converter 2210 may be a low-dropout regulator (LDO).

FIG. 23 is a block diagram of another example charging circuit 2300, in accordance with some embodiments of the present disclosure. The charging circuit 2300 may also be designed for the WVDC architecture. Compared to the charging circuit 2200 of FIG. 22, the charging circuit 2300 further includes a charger transistor 2310 and switch devices 2320 and 2330 electrically coupled to the charger transistor 2310.

As shown in FIG. 23, the charger transistor 2310 is electrically coupled in series between the dc-dc converter 2210 and the battery 1114 and configured to enable or disable charging or discharging of the battery 1114. The switch device 2320 is electrically coupled in parallel to the charger transistor 2310 and configured to bypass the charger transistor 2310 when the switch device 2320 is closed. The switch device 2330 is electrically coupled in parallel to the de-de converter 2210 and configured to enable a direct charging or discharging between the battery 1114 and an output node 2390 of the charging circuit 2300 when the switch device 2330 is closed. In some embodiments, one or more of the charger transistor 2310 and switch devices 2320 and 2330 may be optional.

In particular, the charger transistor 2310 electrically coupled between the de-de converter 2210 and the battery 1114 can minimize voltage and current ripples of the battery voltage Vbat across the battery 1114. Similar to the embodiments above, the charger transistor 2310 and the switch device 2320 may be configured to enable or disable charging or discharging of the battery 1114. Detailed operations of the charger transistor 2310 and the switch device 2320 are similar to those described above, and thus are not repeated herein for the sake of brevity.

In some embodiments, the switch device 2320 and the switch device 2330 can be used to achieve the direct charging of the battery 1114. For example, when the battery 1114 is charged using the output voltage V2 (or the regulated DC voltage V1 from the programmable power supply circuit 1130) directly under a direct charging mode, the switch device 2320 and the switch device 2330 can be closed, in response to a corresponding control command from the controller 1116, to provide a less resistive power path between the battery 1114 and the output node 2390. Accordingly, the overall power efficiency can be improved.

On the other hand, when a voltage conversion between the output voltage V2 and the battery voltage Vbat of the battery 1114 is needed, the switch device 2330 can be opened, and the battery 1114 is charged by the voltage outputted by the dc-dc converter 2210. In other words, the charger transistor 2310, the switch device 2320, and the switch device 2330 can be respectively controlled to operate the charging circuit 2300 under various charging modes according to various system conditions and desired outcomes to supply the output voltage V2 to the load, and to charge or discharge the battery 1114 efficiently without causing damages (e.g., over-charge or over-voltage) to the battery 1114. In some embodiments, the charging circuit 2300 can dynamically switch between different charging modes by detecting the system conditions to optimize its operation automatically.

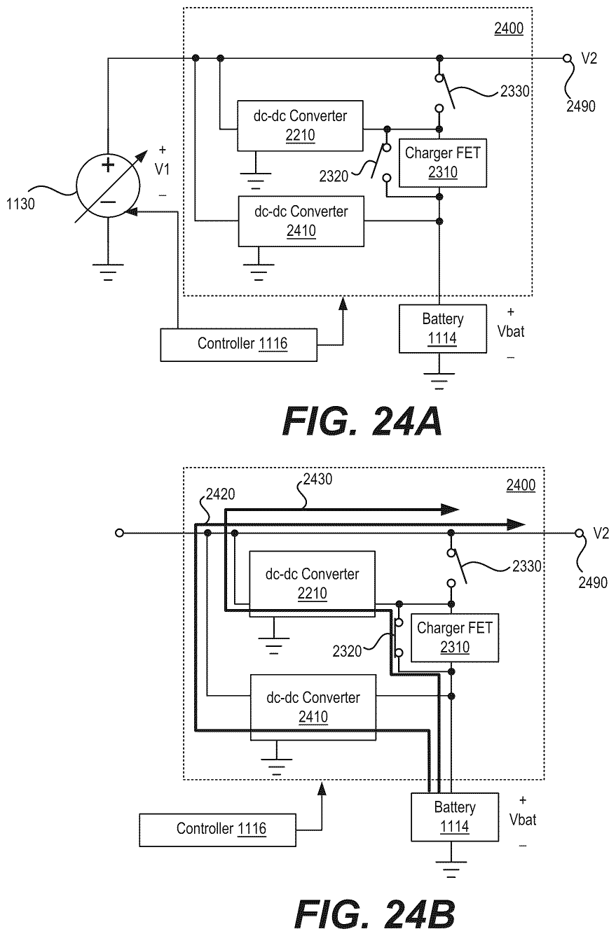

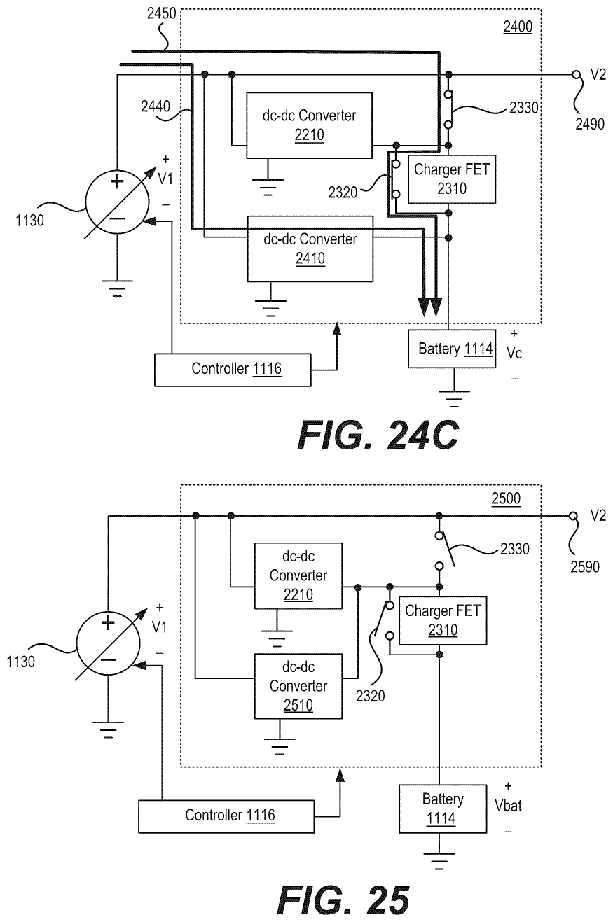

FIG. 24A is a block diagram of another example charging circuit 2400, in accordance with some embodiments of the present disclosure. Compared to the charging circuit 2300 of FIG. 23, the charging circuit 2400 further includes another dc-dc converter 2410. In some embodiments, one of the dc-dc converter 2210 and the dc-dc converter 2410 may be an unregulated converter, which may be a high-efficiency converter, and the other one of the de-dc converter 2210 and the dc-dc converter 2410 may be a regulated converter. As shown in FIG. 24A, the dc-dc converter 2410 is electrically coupled in series between the programmable power supply circuit 1130 and the battery 1114. The charger transistor 2310 is electrically coupled between the dc-dc converter 2210 and the dc-dc converter 2410. In some embodiments, the dc-dc converter 2210 and the dc-dc converter 2410 are configured to operate simultaneously under certain power modes, but the present disclosure is not limited thereto.

FIG. 24B illustrates example power flows during a discharging phase of the battery 1114 in the charging circuit 2400 of FIG. 24A, in accordance with some embodiments of the present disclosure. A power path 2420 in FIG. 24B indicates an example power flow during a discharging phase of the battery 1114. In the power path 2420, during the discharging phase of the battery 1114, the dc-dc converter 2410 is configured to convert the battery voltage Vbat outputted by the battery 1114 to the desired output voltage V2 at an output node 2490 of the charging circuit 2400. As shown in FIG. 24B, in some embodiments, the switch device 2320 can be closed, in response to a corresponding control command from the controller 1116, to provide another power path 2430 during the discharging phase of the battery 1114, in which the dc-dc converter 2210 is configured to convert the battery voltage Vbat outputted by the battery 1114 to the desired output voltage V2. Accordingly, the charging circuit 2400 can supply greater output power in response to the system's request, with relative low power-rating dc-dc converters 2210 and 2410. When the required output power is relatively low, the charging circuit 2400 may also enable one of the dc-dc converters 2210 and 2410 to reduce the power loss and thus improve the overall power efficiency.

FIG. 24C illustrates example power flows during a charging phase of the battery 1114 in the charging circuit 2400 of FIG. 24A, in accordance with some embodiments of the present disclosure. A power path 2440 in FIG. 24C indicates an example power flow during a charging phase of the battery 1114. In the power path 2440, during the charging phase of the battery 1114, the dc-dc converter 2410 is configured to convert the output voltage V2 (or the regulated DC voltage V1 from the programmable power supply circuit 1130) to a desired charging voltage Vc to the battery 1114, in the condition that the output voltage V2 is not within a desired voltage range for charging the battery 1114. On the other hand, when the programmable power supply circuit 1130 is able to provide the regulated DC voltage V1 at an optimized voltage level as the charging voltage Vc to charge the battery 1114 directly, the switch devices 2320 and 2330 can be closed to provide a power path 2450 to enable to a direct charging to improve the efficiency.

It is appreciated that power paths 2420-2450 shown in FIG. 24B and FIG. 24C are merely examples and not meant to limit the present disclosure. In various embodiments, the charging circuit 2400 can control the dc-dc converters 2210 and 2410, the charger transistor 2310, and the switch devices 2320 and 2330 accordingly to operate at a desired charging or discharging mode to charge or discharge the battery 1114 and output the output voltage V2 according to the system's needs using the programmable power supply circuit 1130 or the battery 1114 as the power source.

FIG. 25 is a block diagram of another example charging circuit 2500, in accordance with some embodiments of the present disclosure. Compared to the charging circuit 2300 of FIG. 23, the charging circuit 2500 further includes another dc-dc converter 2510. Similar to the embodiments of FIGS. 24A-24C, one of the dc-dc converter 2210 and the dc-dc converter 2510 may be an unregulated converter, and the other one of the dc-dc converter 2210 and the de-dc converter 2510 may be a regulated converter.

As shown in FIG. 25, the de-de converters 2210 and 2510 are electrically coupled in parallel. In some embodiments, the de-de converter 2210 and the de-dc converter 2510 operate at the same conversion ratio. By arranging the dc-dc converter 2210 and the dc-dc converter 2510 in parallel, the power path providing the output voltage V2 at an output node 2590 or the charging voltage to the battery 1114 can be optimized with the dc-dc converter 2210 and the de-de converter 2510 operating together to provide additional power. Thus, similar to the charging circuit 2400 of FIGS. 24A-24C, the charging circuit 2500 can also supply greater output power in response to the system's request, with relatively low power-rating dc-dc converters 2210 and 2510 to achieve a flash charging. When the required output power is relatively low, the charging circuit 2500 may also enable one of the de-de converters 2210 and 2510 to reduce the power loss and thus improve the overall power efficiency.

Similar to the charging circuit 2400, in some embodiments, the switch device 2320 is electrically coupled in parallel to the charger transistor 2310. In the charging phase of the battery 1114, the switch device 2320 can be closed to bypass the charger transistor 2310 to achieve high-efficiency charging to the battery 1114. In the discharging phase of the battery 1114, the switch device 2320 may be closed to bypass the charger transistor 2310 to provide the output voltage V2 from the battery 1114 directly. Thus, when the power is drawn from the battery 1114, the output voltage V2 may be the battery voltage Vbat, instead of a reduced voltage due to the voltage drop across the charger transistor 2310.

In some embodiments, one or both of the de-de converters 2210 and 2510 may be a boost converter or a charge pump converter to provide a fixed offset between the battery voltage Vbat of the battery 1114 and the output voltage V2 to ensure that the output voltage V2 is at a specific level, when one or both of the switch devices 2320 and 2330 are opened and the power flows through one or both of the dc-dc converters 2210 and 2510. In some other embodiments, the charging circuit 2400 or 2500 may include additional components. The charging circuits shown herein are examples and not meant to limit the present disclosure.

In the above embodiments of FIG. 22 to FIG. 25, the programmable power supply circuit 1130 can be used as an adjustable and dynamic input voltage source in various wide voltage DC architectures to replace the fixed input voltage source in the traditional design. The programmable power supply circuit 1130 can be applied to maximize the power efficiency by regulating the input voltage of the dc-dc converter(s) (e.g., dc-dc converters 2210, 2410, and 2510) in the power converters. In some embodiments, the battery 1114 can be connected to a boost converter or a charge pump converter for outputting a regulated output voltage V2. Accordingly, the voltage range of the output voltage V2 can be narrower. In some embodiments, a fixed offset between the battery voltage Vbat of the battery 1114 and the output voltage V2 can be ensured.

In accordance with various embodiments, various charging circuit architectures are provided to realize a highly efficient power supply system, offer improved charging mode candidates, and increase design flexibility compared to existing solutions. The proposed charging devices or modules can be configured to charge an internal battery within the charging devices or modules and provide the output voltage for charging an electronic device. The user or the controller can leverage the flexibility provided by proposed charging architectures and control methods, so that the charging devices or modules can dynamically switch between different charging modes automatically or in response to manual commands, to adjust the charging efficiency, the charging power, or the required charging time to meet different charging requirements in various applications, and achieve multi-mode battery charging in response to various scenarios and system conditions.

In some embodiments, the proposed charging devices or modules may dynamically switch between different charging/discharging modes in response to various conditions and desired outcomes in real-time. The mode selection may be based on commands from a user to provide a personalized power management strategy for the user, and may also be based on commands from a controller to achieve an optimized power management. Examples of the charging/discharging modes may include a high-power charging mode which requires less charging time to complete the charging process, a high-efficiency charging mode which causes less damages to the battery and extends the battery life and the performance of the battery, various intermediate charging modes balancing the trade-off between the charging time and the efficiency, etc.

In the foregoing specification, embodiments have been described with reference to numerous specific details that can vary from implementation to implementation. Certain adaptations and modifications of the described embodiments can be made. It is also intended that the sequence of steps shown in figures is only for illustrative purposes and is not intended to be limited to any particular sequence of steps. As such, those skilled in the art can appreciate that these steps may be performed in a different order while implementing the same method.

The various example embodiments herein may be described in the general context of method steps or processes, which may be implemented in one aspect by a computer program product, embodied in a transitory or a non-transitory computer-readable medium. For example, a non-transitory computer-readable storage medium may store a set of instructions that are executable by one or more processors of a device to cause the device to perform a method for controlling a charging circuit. A computer-readable medium may include removable and nonremovable storage devices including, but not limited to, Read Only Memory (ROM), Random Access Memory (RAM), compact discs (CDs), digital versatile discs (DVD), etc.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not to be considered essential features of those embodiments unless the embodiment is inoperative without those elements.

Various embodiments may further be described using the following clauses/paragraphs:
1. A power converter for use with a programmable power supply circuit, comprising:
a charging circuit electrically coupled to the programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to a system output voltage at an output node; and
a battery electrically coupled to the first dc-dc converter, and configured to be charged or discharged, directly or indirectly via the output node,
wherein the charging circuit further comprises a charger transistor electrically coupled in series between the first dc-dc converter and the battery via the output node and configured to enable or disable charging or discharging of the battery.
2. The power converter of clause 1, further comprising:
a boost converter or a charge pump converter coupled between the battery and the output node.
3. The power converter of clause 1 or clause 2, further comprising:
a switch device electrically coupled in parallel to the charger transistor and configured to bypass the charger transistor when the switch device is closed.
4. A power converter for use with a programmable power supply circuit, comprising:
a charging circuit electrically coupled to the programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to a system output voltage at an output node; and
a battery electrically coupled to the first dc-dc converter, and configured to be charged or discharged, directly or indirectly via the output node,
wherein the charging circuit further comprises a second dc-dc converter electrically coupled in series between the programmable power supply circuit and the battery, wherein one of the first dc-dc converter and the second dc-dc converter is an unregulated converter.
5. The power converter of clause 4, wherein the first dc-dc converter and the second dc-dc converter are configured to operate simultaneously.
6. The power converter of clause 4 or clause 5, further comprising:
a boost converter or a charge pump converter coupled between the battery and the output node.
7. The power converter of any of clauses 4-6, wherein, in a discharging phase of the battery, the second dc-dc converter is configured to convert a battery voltage outputted by the battery to a first voltage received by the first dc-dc converter, and the first dc-dc converter is configured to regulate and provide the system output voltage, in response to the first voltage from the second dc-dc converter.
8. The power converter of any of clauses 4-7, wherein, in a charging phase of the battery, the first dc-dc converter is configured to provide the system output voltage, in response to the regulated DC input voltage from the programmable power supply circuit, and the second dc-dc converter is configured to provide a charging voltage to the battery, in response to the regulated DC input voltage from the programmable power supply circuit.
9. The power converter of any of clauses 4-8, further comprising:
a charger transistor electrically coupled in series between the first dc-dc converter and the battery via the output node and configured to enable or disable charging or discharging of the battery.
10. The power converter of clause 9, further comprising:
a switch device electrically coupled in parallel to the charger transistor and configured to bypass the charger transistor when the switch device is closed.
11. The power converter of clause 9 or clause 10, wherein the charger transistor is electrically coupled between the first dc-dc converter and the second dc-dc converter.
12. A power converter for use with a programmable power supply circuit, comprising:
a charging circuit electrically coupled to the programmable power supply circuit, the programmable power supply circuit being configured to provide a regulated DC input voltage, the charging circuit comprising:
   a first dc-dc converter electrically coupled to the programmable power supply circuit and configured to convert the regulated DC input voltage to a system output voltage at an output node;
a battery electrically coupled to the first dc-dc converter, and configured to be charged or discharged, directly or indirectly via the output node;
wherein the charging circuit further comprises a second dc-dc converter electrically coupled in series between the programmable power supply circuit and the battery, and the first dc-dc converter and the second dc-dc converter are configured to operate simultaneously.
13. The power converter of clause 12, wherein the first dc-dc converter and the second dc-dc converter are electrically coupled in parallel.
14. The power converter of clause 12 or clause 13, further comprising:
a charger transistor electrically coupled in series between the first dc-dc converter and the battery via the output node and configured to enable or disable charging or discharging of the battery.
15. The power converter of clause 14, further comprising:
a switch device electrically coupled in parallel to the charger transistor and configured to bypass the charger transistor when the switch device is closed.
16. The power converter of clause 14 or clause 15, wherein the charger transistor is electrically coupled between the first dc-dc converter and the second dc-dc converter.
17. A power converter for use with a programmable power supply circuit, comprising: a charging circuit electrically coupled to the programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to a system output voltage at an output node; and
a battery electrically coupled to the first dc-dc converter, and configured to be charged or discharged, directly or indirectly via the output node,
wherein the charging circuit further comprises a boost converter or a charge pump converter electrically coupled between the battery and the output node.
18. The power converter of clause 17, wherein the charging circuit further comprises a second dc-dc converter electrically coupled in series between the programmable power supply circuit and the battery.
19. A power converter for use with a programmable power supply circuit, comprising:
a charging circuit electrically coupled to the programmable power supply circuit, the programmable power supply circuit being configured to provide a regulated DC voltage as a system output voltage at an output node, the charging circuit comprising: a first dc-dc converter electrically coupled to the programmable power supply circuit at the output node, and configured to perform a voltage conversion between the system output voltage and a battery voltage; and
a battery electrically coupled to the first dc-dc converter, and configured to be charged or discharged, directly or indirectly, based on the battery voltage.
20. The power converter of clause 19, further comprising:
a charger transistor electrically coupled in series between the first dc-dc converter and the battery and configured to enable or disable charging or discharging of the battery.
21. The power converter of clause 20, further comprising:
a first switch device electrically coupled in parallel to the charger transistor and configured to bypass the charger transistor when the first switch device is closed.
22. The power converter of clause 20 or clause 21, further comprising:
a second switch device electrically coupled in parallel to the first dc-dc converter and configured to enable a direct charging or discharging between the battery and the output node when the second switch device is closed.
23. The power converter of any of clauses 20-22, further comprising:
a second dc-dc converter electrically coupled between the programmable power supply circuit and the charger transistor.
24. The power converter of clause 23, wherein one of the first dc-dc converter and the second dc-dc converter is an unregulated converter, and the other one of the first dc-dc converter and the second dc-dc converter is a regulated converter.
25. The power converter of clause 23 or clause 24, wherein the charger transistor is electrically coupled between the first dc-dc converter and the second dc-dc converter.
26. The power converter of any of clauses 23-25, wherein the first dc-dc converter and the second dc-dc converter are electrically coupled in parallel.
27. A method for charging and discharging a battery, comprising:
during a first period, converting, by a first dc-dc converter electrically coupled to a programmable power supply circuit, a regulated DC input voltage to a system output voltage at an output node;
during a charging period of the first period, charging a battery electrically coupled to the first dc-dc converter, directly or indirectly via the output node, based on the system output voltage; and
during a second period, discharging the battery to provide the system output voltage, via the output node, wherein the regulated DC input voltage is outputted by the programmable power supply circuit during the first period.
28. The method of clause 27, further comprising:
enabling or disabling charging or discharging of the battery via a charger transistor electrically coupled in series between the first dc-dc converter and the battery via the output node.
29. The method of clause 28, further comprising:
during the charging period or the second period, closing a switch device electrically coupled in parallel to the charger transistor to bypass the charger transistor.
30. The method of clause 28 or clause 29, further comprising:
operating the first dc-dc converter and a second dc-dc converter electrically coupled in series between the programmable power supply circuit and the battery simultaneously to provide the system output voltage at the output node.
31. The method of clause 30, wherein operating the first dc-dc converter and the second dc-dc converter comprises:
during the second period, converting, by the second dc-dc converter, a battery voltage outputted by the battery to a first voltage; and
regulating the first voltage, by the first dc-dc converter, to provide the system output voltage.
32. The method of clause 30 or clause 31, wherein operating the first dc-dc converter and the second dc-dc converter comprises:
during the charging period, regulating and providing the system output voltage, by the first dc-dc converter, in response to the regulated DC input voltage from the programmable power supply circuit; and
providing a charging voltage to the battery, by the second dc-dc converter, in response to the regulated DC input voltage from the programmable power supply circuit.
33. The method of any of clauses 30-32, wherein one of the first dc-dc converter and the second dc-dc converter is an unregulated converter.
34. The method of any of clauses 30-33, wherein the charger transistor is electrically coupled between the first dc-dc converter and the second dc-dc converter.
35. The method of any of clauses 30-34, wherein the first dc-dc converter and the second dc-dc converter are electrically coupled in parallel.
36. The method of clause 35, further comprising:
during the charging period, closing a switch device electrically coupled in parallel to the charger transistor to bypass the charger transistor.
37. The method of clause 36, further comprising:
during the second period, closing the switch device to bypass the charger transistor to provide the system output voltage from the battery.
38. A method for charging and discharging a battery, comprising:
during a charging period of a first period, charging, by a first dc-dc converter electrically coupled to a programmable power supply circuit at an output node, a battery electrically coupled to the first dc-dc converter, directly or indirectly via the output node, based on a system output voltage by performing a voltage conversion between the system output voltage and a battery voltage of the battery; and
during a second period, discharging the battery to provide the system output voltage, via the output node,
wherein the system output voltage is a regulated DC voltage outputted by the programmable power supply circuit at the output node during the first period.
39. The method of clause 38, further comprising:
enabling or disabling charging or discharging of the battery via a charger transistor electrically coupled in series between the first dc-dc converter and the battery via the output node.
40. The method of clause 39, further comprising:
during the charging period or the second period, closing a first switch device electrically coupled in parallel to the charger transistor to bypass the charger transistor.
41. The method of clause 39 or clause 40, further comprising:
during the charging period or the second period, closing a second switch device electrically coupled in parallel to the first dc-dc converter to enable a direct charging or discharging between the battery and the output node.
42. The method of any of clauses 39-41, further comprising:
operating the first dc-dc converter and a second dc-dc converter electrically coupled between the programmable power supply circuit and the charger transistor, wherein one of the first dc-dc converter and the second dc-dc converter is an unregulated converter, and the other one of the first dc-dc converter and the second dc-dc converter is a regulated converter.
43. The method of clause 42, wherein the charger transistor is electrically coupled between the first dc-dc converter and the second dc-dc converter.
44. The method of clause 42 or clause 43, wherein the first dc-dc converter and the second dc-dc converter are electrically coupled in parallel.

Various embodiments may further be described using the following clauses/paragraphs:
1. A method for controlling a charging circuit, comprising: receiving battery information of a battery from an electrical device to be charged; receiving one or more characteristic parameters from the electrical device; selecting, from a plurality of charging mode candidates, a target charging mode according to the battery information and the one or more characteristic parameters; and controlling a controller to adjust one or more operating parameters of the charging circuit based on the selected target charging mode for charging the electrical device.
2. The method as paragraph 1 describes, wherein the one or more characteristic parameters comprise data associated with the electrical device, including a device type, a use pattern of a user of the electrical device, location information, position information, time information, movement information, device temperature information, ambient temperature information, real-time power consumption information, real-time carbon emission information, historical power consumption information, or any combination thereof.
3. The method as either of paragraphs 1 or 2 describe, wherein the device temperature information comprises one or more of an average device temperature, a maximum device temperature, or a device skin temperature.
4. The method as any of paragraphs 1-3 describe, wherein the battery information comprises a battery state of charge, a battery state of health, a temperature of the battery, or a combination thereof.
5. The method as any of paragraphs 1-4 describe, wherein controlling the controller to adjust the one or more operation parameters of the charging circuit based on the selected target charging mode comprises: adjusting a charging efficiency or a charging power or time to reach a percentage of full charge of a battery.
6. The method as any of paragraphs 1-5 describe, wherein the one or more operation parameters are associated with one or more of a voltage level of a supply voltage outputted by an adjustable voltage source in the charging circuit, an architecture of the charging circuit, or a power flow direction of one or more power converters in the charging circuit.
7. The method as any of paragraphs 1-6 describe, wherein controlling the controller to adjust the one or more operation parameters of the charging circuit based on the selected target charging mode comprises: selectively enabling or disabling one or more power converters in the charging circuit based on the selected target charging mode.
8. The method as any of paragraphs 1-7 describe, wherein controlling the controller to adjust the one or more operation parameters of the charging circuit based on the selected target charging mode comprises: selectively controlling a voltage level of a supply voltage outputted by an adjustable voltage source in the charging circuit, based on the selected target charging mode.
9. The method as any of paragraphs 1-8 describe, wherein controlling the controller to adjust the one or more operation parameters of the charging circuit based on the selected target charging mode comprises: selectively controlling a power flow direction of one or more power converters in the charging circuit, based on the selected target charging mode.
10. The method as any of paragraphs 1-9 describe, wherein selectively controlling the power flow direction of the one or more power converters in the charging circuit further comprises: in response to a first charging mode being selected, controlling a target power converter to receive an input power from a first end and provide an output power through a second end; in response to a second charging mode being selected, controlling the target power converter to receive the input power from the second end and provide the output power through the first end.
11. The method as any of paragraphs 1-10 describe, wherein selectively controlling the power flow direction of the one or more power converters in the charging circuit further comprises: in response to a third charging mode being selected, disabling the target power converter to stop power from flowing through the target power converter.
12. The method as any of paragraphs 1-11 describe, wherein controlling the controller to operate the charging circuit based on the selected target charging mode comprises: selectively enabling or disabling one or more switch devices to bypass a charger transistor in the charging circuit, based on the selected target charging mode.
13. The method as any of paragraphs 1-12 describe, further comprising: in response to a detection of a mode selection command from a user, selecting, from the plurality of charging mode candidates, the target charging mode according to the mode selection command.
14. The method as any of paragraphs 1-13 describe, further comprising: determining a plurality of operating parameters for operating the charging circuit according to the selected target charging mode and an architecture of the charging circuit.
15. The method as any of paragraphs 1-14 describe, further comprising: retrieving, according to the target charging mode and the architecture of the charging circuit, a corresponding target set of the operating parameters selected from a plurality of candidate sets of the operating parameters stored in a memory.
16. The method as any of paragraphs 1-15 describe, further comprising: obtaining each candidate set by a processor, each candidate set being associated with the architecture of the charging circuit and one of the charging mode candidates.
17. The method as any of paragraphs 1-16 describe, wherein obtaining each candidate set by the processor comprises: applying a neural network to process a plurality of input parameters to obtain each candidate set.
18. The method as any of paragraphs 1-17 describe, wherein the input parameters for the neural network comprise the target charging mode, the architecture of the charging circuit, ambient temperature, and the battery information.
19. The method as any of paragraphs 1-18 describe, wherein the neural network is configured to perform a regression between a set of the operating parameters and a corresponding charging efficiency or a corresponding charging power or time to reach a percentage of full charge of a battery.
20. The method as any of paragraphs 1-19 describe, wherein the neural network is a perceptron network, a classifier network, an optimization network, or any combination thereof.
21. The method as any of paragraphs 1-20 describe, further comprising: changing the target charging mode during a charging cycle of the battery.
22. A controller for controlling a charging circuit, comprising: a memory storing a set of instructions; one or more processors coupled to the memory and configured to execute the set of instructions to cause the controller to perform operations comprising: selecting, from a plurality of charging mode candidates, a target charging mode according to battery information of a battery and one or more characteristic parameters received from an electrical device to be charged; and adjusting one or more operating parameters of the charging circuit based on the selected target charging mode for charging the electrical device.
23. The controller as paragraph 22 describes, wherein the one or more characteristic parameters comprise data associated with the electrical device, including a device type, a use pattern of a user of the electrical device, location information, position information, time information, movement information, device temperature information, ambient temperature information, real-time power consumption information, real-time carbon emission information, historical power consumption information, or any combination thereof.
24. The controller as either of paragraphs 22 or 23 describe, wherein the device temperature information comprises one or more of an average device temperature, a maximum device temperature, or a device skin temperature.
25. The controller as any of paragraphs 22-24 describe, wherein the battery information comprises a battery state of charge, a battery state of health, a temperature of the battery, or a combination thereof.
26. The controller as any of paragraphs 22-25 describe, wherein the operations further comprise: adjusting the one or more operation parameters of the charging circuit based on the selected target charging mode to adjust a charging efficiency or a charging power or time to reach a percentage of full charge of a battery.
27. The controller as any of paragraphs 22-26 describe, wherein the one or more operation parameters are associated with one or more of a voltage level of a supply voltage outputted by an adjustable voltage source in the charging circuit, an architecture of the charging circuit, or a power flow direction of one or more power converters in the charging circuit.
28. The controller as any of paragraphs 22-27 describe, wherein the operations further comprise: selectively enabling or disabling one or more power converters in the charging circuit based on the selected target charging mode.
29. The controller as any of paragraphs 22-28 describe, wherein the operations further comprise: selectively controlling a voltage level of a supply voltage outputted by an adjustable voltage source in the charging circuit, based on the selected target charging mode.
30. The controller as any of paragraphs 22-29 describe, wherein the operations further comprise: selectively controlling a power flow direction of one or more power converters in the charging circuit, based on the selected target charging mode.
31. The controller as any of paragraphs 22-30 describe, wherein the controller is configured to control a target power converter to receive an input power from a first end and provide an output power through a second end in response to a first charging mode being selected, and control the target power converter to receive the input power from the second end and provide the output power through the first end in response to a second charging mode being selected.
32. The controller as any of paragraphs 22-31 describe, wherein the controller is configured to disable the target power converter to stop power from flowing through the target power converter in response to a third charging mode being selected.
33. The controller as any of paragraphs 22-32 describe, wherein the operations further comprise: selectively enabling or disabling one or more switch devices to bypass a charger transistor in the charging circuit, based on the selected target charging mode.
34. The controller as any of paragraphs 22-33 describe, wherein the operations further comprise: in response to a detection of a mode selection command from a user, selecting, from the plurality of charging mode candidates, the target charging mode according to the mode selection command.
35. The controller as any of paragraphs 22-34 describe, wherein the operations further comprise: determining a plurality of operating parameters for operating the charging circuit according to the selected target charging mode and an architecture of the charging circuit.
36. The controller as any of paragraphs 22-35 describe, wherein the operations further comprise: retrieving, according to the target charging mode and the architecture of the charging circuit, a corresponding target set of the operating parameters selected from a plurality of candidate sets of the operating parameters stored in a memory.
37. The controller as any of paragraphs 22-36 describe, wherein each candidate set is associated with one of the charging mode candidates and the architecture of the charging circuit and obtained by a processor.
38. The controller as any of paragraphs 22-37 describe, wherein each candidate set is obtained by the processor by applying a neural network to process a plurality of input parameters.
39. The controller as any of paragraphs 22-38 describe, wherein the input parameters for the neural network comprise the target charging mode, the architecture of the charging circuit, ambient temperature, and the battery information.
40. The controller as any of paragraphs 22-39 describe, wherein the neural network is configured to perform a regression between a set of the operating parameters and a corresponding charging efficiency or a corresponding charging power or time to reach a percentage of full charge of a battery.
41. The controller as any of paragraphs 22-40 describe, wherein the neural network is a perceptron network, a classifier network, an optimization network, or any combination thereof.
42. The controller as any of paragraphs 22-41 describe, wherein the operations further comprise: changing the target charging mode during a charging cycle of the battery.
43. A charging device, comprising: a charging circuit electrically coupled to a programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to an output voltage at an output node; and a controller configured to: receive battery information from an electrical device to be charged; receive one or more characteristic parameters; select, from a plurality of charging mode candidates, a target charging mode according to the battery information and the one or more characteristic parameters; and adjust one or more operating parameters of the charging circuit based on the selected target charging mode for charging an electrical device.
44. The charging device as paragraph 43 describes, wherein the one or more characteristic parameters comprise data associated with the electrical device, including a device type, a use pattern of a user of the electrical device, location information, position information, time information, movement information, device temperature information, ambient temperature information, real-time power consumption information, real-time carbon emission information, historical power consumption information, or any combination thereof.
45. The charging device as either of paragraphs 43 or 44 describe, wherein the device temperature information comprises one or more of an average device temperature, a maximum device temperature, or a device skin temperature.
46. The charging device as any of paragraphs 43-45 describe, wherein the battery information comprises a battery state of charge, a battery state of health, a temperature of the battery, or a combination thereof.
47. The charging device as any of paragraphs 43-46 describe, wherein the controller is configured to adjust the one or more operation parameters of the charging circuit based on the selected target charging mode to: adjust a charging efficiency or a charging power or time to reach a percentage of full charge of a battery.
48. The charging device as any of paragraphs 43-47 describe, wherein the one or more operation parameters are associated with one or more of a voltage level of a supply voltage outputted by an adjustable voltage source in the charging circuit, an architecture of the charging circuit, or a power flow direction of one or more power converters in the charging circuit.
49. The charging device as any of paragraphs 43-48 describe, further comprising: a battery electrically coupled to the first dc-dc converter, and configured to be charged or discharged, directly or indirectly via the output node; wherein the charging circuit further comprises a second dc-dc converter electrically coupled in series between the programmable power supply circuit and the battery, one of the first dc-dc converter and the second dc-dc converter being an unregulated converter; and wherein the controller is further configured to selectively enable or disable the first dc-dc converter or the second dc-dc converter based on the selected target charging mode.
50. The charging device as any of paragraphs 43-49 describe, wherein the controller is further configured to selectively control a voltage level of the regulated DC input voltage, based on the selected target charging mode.
51. The charging device as any of paragraphs 43-50 describe, further comprising: a battery electrically coupled to the first dc-dc converter, and configured to be charged or discharged, directly or indirectly via the output node; wherein the charging circuit further comprises a second dc-dc converter electrically coupled in series between the programmable power supply circuit and the battery, one of the first dc-dc converter and the second dc-dc converter being an unregulated converter; and wherein the controller is further configured to selectively control a power flow direction of the first dc-dc converter and the second dc-dc converter, based on the selected target charging mode.
52. The charging device as any of paragraphs 43-51 describe, wherein the controller is configured to control the second dc-dc converter to receive an input power from a first end and provide an output power through a second end in response to a first charging mode being selected, and control the second dc-dc converter to receive the input power from the second end and provide the output power through the first end in response to a second charging mode being selected.
53. The charging device as any of paragraphs 43-52 describe, wherein the controller is configured to disable the second dc-dc converter to stop power from flowing through the second dc-dc converter in response to a third charging mode being selected.
54. The charging device as any of paragraphs 43-53 describe, wherein the charging circuit further comprises: a battery electrically coupled to the first dc-dc converter, and configured to be charged or discharged, directly or indirectly via the output node; a charger transistor electrically coupled in series between the first dc-dc converter and the battery via the output node and configured to enable or disable charging or discharging of the battery; and a switch device electrically coupled in parallel to the charger transistor and configured to bypass the charger transistor when the switch device is closed; wherein the controller is further configured to selectively enable or disable the switch device to bypass the charger transistor, based on the selected target charging mode.
55. The charging device as any of paragraphs 43-54 describe, wherein in response to a detection of a mode selection command from a user, the controller is further configured to select, from the plurality of charging mode candidates, the target charging mode according to the mode selection command.
56. The charging device as any of paragraphs 43-55 describe, wherein the controller is further configured to determine a plurality of operating parameters for operating the charging circuit according to the selected target charging mode and an architecture of the charging circuit.
57. The charging device as any of paragraphs 43-56 describe, wherein the controller is further configured to retrieve, according to the target charging mode and the architecture of the charging circuit, a target set of the operating parameters selected from a plurality of candidate sets of the operating parameters stored in a memory.
58. The charging device as any of paragraphs 43-57 describe, wherein each candidate set is obtained by a processor and associated with one of the charging mode candidates and the architecture of the charging circuit.
59. The charging device as any of paragraphs 43-58 describe, wherein the processor is configured to apply a neural network to process a plurality of input parameters to obtain each candidate set.
60. The charging device as any of paragraphs 43-59 describe, wherein the input parameters for the neural network comprise the target charging mode, the architecture of the charging circuit, ambient temperature, and the battery information.
61. The charging device as any of paragraphs 43-60 describe, wherein the neural network is configured to perform a regression between a set of the operating parameters and a corresponding charging efficiency or a corresponding charging power or time to reach a percentage of full charge of a battery.
62. The charging device as any of paragraphs 43-61 describe, wherein the neural network is a perceptron network, a classifier network, an optimization network, or any combination thereof.
63. The charging device as any of paragraphs 43-62 describe, wherein the controller is further configured to change the target charging mode during a charging cycle of the battery.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A power converter for use with a programmable power supply circuit, the programmable power supply circuit configured to provide a regulated DC input voltage, the power converter comprising:
a battery configured to be charged or discharged, directly or indirectly via a node; and
a charging circuit comprising:
a first dc-dc converter coupled to the battery, wherein the first dc-dc converter is configured to be coupled to the programmable power supply circuit and configured to convert the regulated DC input voltage to a system output voltage at the node; and
a charger transistor coupled in series between the first dc-dc converter and the battery via the node and configured to enable or disable charging or discharging of the battery.

2. The power converter of claim 1, further comprising:
a boost converter or a charge pump converter coupled between the battery and the node.

3. The power converter of claim 1, further comprising:
a switch device coupled in parallel to the charger transistor and configured to bypass the charger transistor when the switch device is closed.

4. A power converter for use with a programmable power supply circuit, the programmable supply circuit configured to provide a regulated DC input voltage, the power converter comprising:
a battery configured to be charged or discharged, directly or indirectly via a node; and
a charging circuit comprising:
a first dc-dc converter coupled to the battery, wherein the first dc-dc converter is configured to be coupled to the programmable power supply circuit and configured to convert the regulated DC input voltage to a system output voltage at the node; and
a boost converter or a charge pump converter coupled between the battery and the node.

5. The power converter of claim 4, wherein the charging circuit further comprises a second dc-dc converter configured to be coupled in series between the programmable power supply circuit and the battery.

6. A method for charging and discharging a battery, the method comprising:
during a first period, converting, by a first dc-dc converter electrically coupled to the battery and to a programmable power supply circuit, a regulated DC input voltage to a system output voltage at a node;
during a charging period of the first period, charging the battery directly or indirectly via the node based on the system output voltage; and
during a second period, discharging the battery to provide the system output voltage via the node,
wherein the regulated DC input voltage is outputted by the programmable power supply circuit during the first period.

7. The method of claim 6, further comprising:
enabling or disabling charging or discharging of the battery via a charger transistor electrically coupled in series between the first dc-dc converter and the battery via the node.

8. The method of claim 7, further comprising:
during the charging period or the second period, closing a switch device electrically coupled in parallel to the charger transistor to bypass the charger transistor.

9. The method of claim 7, further comprising:
operating the first dc-dc converter and a second dc-dc converter electrically coupled in series between the programmable power supply circuit and the battery simultaneously to provide the system output voltage at the node.

10. The method of claim 9, wherein the operating the first dc-dc converter and the second dc-dc converter comprises:
during the second period, converting, by the second dc-dc converter, a battery voltage outputted by the battery to a first voltage; and
regulating the first voltage, by the first dc-dc converter, to provide the system output voltage.

11. The method of claim 9, wherein the operating the first dc-dc converter and the second dc-dc converter comprises:
during the charging period, regulating and providing the system output voltage, by the first dc-dc converter, in response to the regulated DC input voltage from the programmable power supply circuit; and
providing a charging voltage to the battery, by the second dc-dc converter, in response to the regulated DC input voltage from the programmable power supply circuit.

12. The method of claim 9, wherein one of the first dc-dc converter or the second dc-dc converter is an unregulated converter.

13. The method of claim 9, wherein the charger transistor is electrically coupled between the first dc-dc converter and the second dc-dc converter.

14. The method of claim 9, wherein the first dc-dc converter and the second dc-dc converter are electrically coupled in parallel.

15. The method of claim 14, further comprising:
during the charging period, closing a switch device electrically coupled in parallel to the charger transistor to bypass the charger transistor.

16. The method of claim 15, further comprising:
during the second period, closing the switch device to bypass the charger transistor to provide the system output voltage from the battery.

17. A method for charging and discharging a battery, the method comprising:
during a charging period of a first period, charging, by a first dc-dc converter electrically coupled to a programmable power supply circuit at a node, a battery electrically coupled to the first dc-dc converter, directly or indirectly via the node, based on a system output voltage by performing a voltage conversion between the system output voltage and a battery voltage of the battery; and
during a second period, discharging the battery to provide the system output voltage via the node,
wherein the system output voltage is a regulated DC voltage outputted by the programmable power supply circuit at the node during the first period.

18. The method of claim 17, further comprising:
enabling or disabling charging or discharging of the battery via a charger transistor electrically coupled in series between the first dc-dc converter and the battery via the node.

19. The method of claim 18, further comprising:
during the charging period or the second period, closing a first switch device electrically coupled in parallel to the charger transistor to bypass the charger transistor.

20. The method of claim 18, further comprising:
during the charging period or the second period, closing a second switch device electrically coupled in parallel to the first dc-dc converter to enable a direct charging or discharging between the battery and the node.

21. The method of claim 18, further comprising:
operating the first dc-dc converter and a second dc-dc converter electrically coupled between the programmable power supply circuit and the charger transistor, wherein one of the first dc-dc converter or the second dc-dc converter is an unregulated converter, and the other one of the first dc-dc converter or the second dc-dc converter is a regulated converter.

22. The method of claim 21, wherein the charger transistor is electrically coupled between the first dc-dc converter and the second dc-dc converter.

23. The method of claim 21, wherein the first dc-dc converter and the second dc-dc converter are electrically coupled in parallel.

24. A controller for controlling a charging circuit, the controller comprising:
a memory configured to store a set of instructions;
one or more processors coupled to the memory and configured to execute the set of instructions to cause the controller to perform operations comprising:
selecting, from a plurality of charging mode candidates, a target charging mode according to battery information of a battery and one or more characteristic parameters received from an electrical device to be charged; and
adjusting one or more operating parameters of the charging circuit based on the selected target charging mode for charging the electrical device.

25. The controller of claim 24, wherein the one or more characteristic parameters comprise data associated with the electrical device, the data including a device type, a use pattern of a user of the electrical device, location information, position information, time information, movement information, device temperature information, ambient temperature information, real-time power consumption information, real-time carbon emission information, historical power consumption information, or any combination thereof.

26. The controller of claim 25, wherein the device temperature information comprises one or more of an average device temperature, a maximum device temperature, or a device skin temperature.

27. The controller of claim 24, wherein the battery information comprises a battery state of charge, a battery state of health, a temperature of the battery, or a combination thereof.

28. The controller of claim 24, wherein the operations further comprise:
adjusting the one or more operating parameters of the charging circuit based on the selected target charging mode to adjust a charging efficiency or a charging power or time to reach a percentage of full charge of the battery.

29. The controller of claim 24, wherein the one or more operating parameters are associated with one or more of a voltage level of a supply voltage outputted by an adjustable voltage source of the charging circuit, an architecture of the charging circuit, or a power flow direction of one or more power converters of the charging circuit.

30. The controller of claim 24, wherein the operations further comprise:
selectively enabling or disabling one or more power converters of the charging circuit based on the selected target charging mode.

31. The controller of claim 24, wherein the operations further comprise:
selectively controlling a voltage level of a supply voltage outputted by an adjustable voltage source of the charging circuit, based on the selected target charging mode.

32. The controller of claim 24, wherein the operations further comprise:
selectively controlling a power flow direction of one or more power converters of the charging circuit, based on the selected target charging mode.

33. The controller of claim 32, wherein the controller is configured to control a target power converter to receive an input power from a first end and provide an output power through a second end in response to a first charging mode being selected, and configured to control the target power converter to receive the input power from the second end and provide the output power through the first end in response to a second charging mode being selected.

34. The controller of claim 33, wherein the controller is configured to disable the target power converter to stop power from flowing through the target power converter in response to a third charging mode being selected.

35. The controller of claim 24, wherein the operations further comprise:
selectively enabling or disabling one or more switch devices to bypass a charger transistor of the charging circuit, based on the selected target charging mode.

36. The controller of claim 24, wherein the operations further comprise:
in response to a detection of a mode selection command from a user, selecting, from the plurality of charging mode candidates, the target charging mode according to the mode selection command.

37. The controller of claim 24, wherein the operations further comprise:
determining a plurality of operating parameters for operating the charging circuit according to the selected target charging mode and an architecture of the charging circuit.

38. The controller of claim 37, wherein the operations further comprise:
retrieving, according to the target charging mode and the architecture of the charging circuit, a corresponding target set of the plurality of operating parameters selected from a plurality of candidate sets of the plurality of operating parameters stored in a second memory.

39. The controller of claim 38, wherein each candidate set is associated with one of the plurality of charging mode candidates and the architecture of the charging circuit and is obtained by a processor.

40. The controller of claim 39, wherein each candidate set is obtained by the processor by applying a neural network to process a plurality of input parameters.

41. The controller of claim 40, wherein the input parameters for the neural network comprise the target charging mode, the architecture of the charging circuit, an ambient temperature, and the battery information.

42. The controller of claim 40, wherein the neural network is configured to perform a regression between a set of the plurality of operating parameters and a corresponding charging efficiency or a corresponding charging power or time to reach a percentage of full charge of the battery.

43. The controller of claim 40, wherein the neural network is a perceptron network, a classifier network, an optimization network, or any combination thereof.

44. The controller of claim 24, wherein the operations further comprise:
changing the target charging mode during a charging cycle of the battery.
